(19) United States
(12) Patent Application Publication
(10) Pub. No.: US 2024/0178955 A1
(43) Pub. Date: May 30, 2024

(54) TRANSMISSION PRECODER DETERMINATION AND SPATIAL RELATION INDICATION

(71) Applicant: ZTE Corporation, Shenzhen (CN)

(72) Inventors: Yang ZHANG, Shenzhen (CN); Bo GAO, Shenzhen (CN); Ke YAO, Shenzhen (CN); Shujuan ZHANG, Shenzhen (CN); Xiaolong GUO, Shenzhen (CN); Meng MEI, Shenzhen (CN); Zhaohua LU, Shenzhen (CN)

(21) Appl. No.: 18/532,121

(22) Filed: Dec. 7, 2023

Related U.S. Application Data
(63) Continuation of application No. PCT/CN2022/112225, filed on Aug. 12, 2022.

(51) Int. Cl. H04L 5/00; H04B 7/024; H04B 7/06; H04W 72/21

(52) U.S. Cl. CPC H04L 5/0035; H04B 7/024; H04B 7/0634; H04L 5/0048; H04W 72/21

(57) ABSTRACT

A method of wireless communication includes transmitting, upon determining that a wireless device operating in a multiple transmission reception point wireless configuration with a network device satisfies a condition, one or more uplink control transmissions by the wireless device using one or more of precoding matrices, wherein the one or more precoding matrices are based on a configuration information received from a network device.

### TECHNICAL FIELD CROSS REFERENCE TO RELATED APPLICATIONS

This patent document is a continuation of and claims benefit of priority to International Patent Application No. PCT/CN2022/112225, filed on Aug. 12, 2022. The entire content of the before-mentioned patent application is incorporated by reference as part of the disclosure of this application.

### TECHNICAL FIELD

This document relates to systems, devices and techniques for wireless communications.

### BACKGROUND

Efforts are currently underway to define next generation wireless communication networks that provide greater deployment flexibility, support for a multitude of devices and services and different technologies for efficient bandwidth utilization.

### SUMMARY

Various methods and apparatus for achieving different reference signal densities in a wireless communication system are described.

In one example aspect, a method of wireless communication is disclosed. The method includes transmitting, upon determining that a wireless device operating in a multiple transmission reception point wireless configuration with a network device satisfies a condition, one or more uplink control transmissions by the wireless device using one or more of precoding matrices, wherein the one or more precoding matrices are based on a configuration information received from a network device.

In another example aspect, another method of wireless communication is disclosed. The method includes transmitting, upon determining that a wireless device operating in a multiple transmission reception point wireless configuration with a network device satisfies a condition, one or more uplink control transmissions by the wireless device using one or more sounding reference signal resource indicators according to a rule; wherein the sounding reference signal (SRS) resource indicators are based on a configuration information received from a network device.

In another example aspect, another method of wireless communication is disclosed. The method includes transmitting, upon determining that a wireless device operating in a multiple transmission reception point wireless configuration with a network device satisfies a condition, codebook based one or more uplink control transmissions by the wireless device using one or more sounding reference signal resource indicators according to a rule; wherein the sounding reference signal resource indicators are based on a configuration information received from a network device.

In another example aspect, another method of wireless communication is disclosed. The method includes transmitting, by a network device to a wireless device, configuration information indicative of one or more precoding matrices to be used by the wireless device for one or more uplink control transmissions upon satisfying a condition while operating in a multiple transmission reception point configuration; and receiving the one or more uplink control transmissions according to the configuration information.

In another example aspect, another method of wireless communication is disclosed. The method includes transmitting, by a network device to a wireless device, configuration information indicative of one or more sounding reference signal resource indicators to be used by the wireless device for one or more uplink control transmissions using a rule upon satisfying a condition while operating in a multiple transmission reception point configuration; and receiving the one or more uplink control transmissions according to the configuration information.

In another example aspect, another method of wireless communication is disclosed. The method includes transmitting, by a network device to a wireless device, configuration information indicative of one or more sounding reference signal resource indicators to be used by the wireless device for codebook-based one or more uplink control transmissions according to a rule upon satisfying a condition while operating in a multiple transmission reception point configuration; and receiving the one or more uplink control transmissions according to the configuration information.

In yet another example aspect, a wireless communications apparatus comprising a processor is disclosed. The processor is configured to implement methods described herein.

In another example aspect, the various techniques described herein may be embodied as processor-executable code and stored on a computer-readable program medium.

The details of one or more implementations are set forth in the accompanying drawings, and the description below. Other features will be apparent from the description and drawings, and from the claims.

### BRIEF DESCRIPTION OF THE DRAWINGS

FIG. 1 is a block diagram of an example of a wireless communication apparatus.

FIG. 2 shows an example wireless communications network.

FIGS. 3A-3F are flowcharts of example wireless communication methods based on some implementations of the disclosed technology.

### DETAILED DESCRIPTION

Section headings are used in the present document only to improve readability and do not limit scope of the disclosed embodiments and techniques in each section only to that section. Furthermore, some embodiments are described with reference to Third Generation Partnership Project (3GPP) New Radio (NR) standard (“5G”) for ease of understanding and the described technology may be implemented in different wireless system that implement protocols other than the 5G protocol.

In the current 5G NR system, several transmission schemes of multiple transmission reception point (MTRP) operation have been supported for uplink (UL) transmissions on top of single transmission reception point (STRP) operation to improve the reliability and throughput of UL channels or signals. However, due to the restriction of the current UE capability, multiple uplink transmissions can only be performed as non-overlapped in time domain even though the UE is equipped with more than one panel, which would be a bottleneck for the reliability and throughput of whole system once multi-TRP based uplink transmission can be supported.

With the evolution of the mobile communication technology, the UE equipped with multiple panels could be supported to simultaneously transmit more than one uplink transmission. On the other hand, due to different channel conditions of the link between multiple panels of the UE and multiple TRPs when MTRP operation, some transmission parameters (e.g., transmission precoder and spatial relation indication) should be dedicated between the panel and TRP for better performance.

Based on the above, some specific issues need to be addressed for the case of simultaneous uplink transmission across multiple UE panels and towards different TRPs: (i) how to determine the precoder for simultaneous control channel transmission repetitions, e.g., physical uplink shared channel PUSCH repetition in MTRP operation? (ii) how to determine the precoder for simultaneous control channel transmission occasions, e.g., PUSCH transmission (which is non-repetition) in MTRP operation? (iii) how to determine the spatial relation indication for simultaneous PUSCH repetition in MTRP operation? (iv) how to determine the spatial relation indication for simultaneous PUSCH transmission in MTRP operation?

The present document provides techniques that may be used, among others, by embodiments of a network device (e.g., a base station) and a wireless device (e.g., a user equipment UE).

In Rel-15 and Rel-16 NR, due to PUSCH transmission towards a single TRP only, the UE uses a same indicated information for the repeated transmission across multiple slots, which means that each of these transmissions uses the same spatial relation and transmission precoder. Note that both codebook based and non-codebook based PUSCH transmission are supported since Rel-15.

For codebook based PUSCH transmission, PUSCH can be scheduled by downlink control information DCI (i.e., DCI format 0_0, DCI format 0_1, DCI format 0_2) or RRC signaling (i.e., the higher layer parameter ConfiguredGrantConfig), and the UE determines its PUSCH transmission precoder based on SRI, TPMI and the transmission rank. Where the SRI, TPMI and the transmission rank are given by some fields in DCI (i.e., SRS resource indicator field, Second SRS resource indicator field, Second Precoding information and number of layers field, Precoding information and number of layers field) or given by some higher layer parameters in RRC signaling (i.e., srs-ResourceIndicator, srs-ResourceIndicator2, precodingAndNumberOfLayers, precodingAndNumberOfLayers2).

For non-codebook based PUSCH transmission, in contrast to codebook based scheme, the UE determines its precoder and transmission rank based on the SRI when multiple SRS resources are configured in a SRS resource set, where the SRI is given by the SRS resource indicator in DCI. Specifically, the UE shall use one or multiple SRS resources for SRS transmission, where, in a SRS resource set, the maximum number of SRS resources which can be configured to the UE for simultaneous transmission in the same symbol and the maximum number of SRS resources are UE capabilities. The SRS resources transmitted simultaneously occupy the same RBs. Only one SRS port for each SRS resource is configured. Only one SRS resource set can be configured with higher layer parameter usage in SRS-ResourceSet set to ‘nonCodebook’. The maximum number of SRS resources in one SRS resource set that can be configured for non-codebook based PUSCH transmission is 4. The indicated SRI in slot n is associated with the most recent transmission of SRS resource(s) identified by the SRI, where the SRS transmission is prior to the PDCCH carrying the SRI. After that, the UE can calculate the precoder used for the transmission of SRS based on measurement of an associated NZP CSI-RS resource. The UE selection of a precoder (and the number of layers) for each scheduled PUSCH may be modified by the network (in case multiple SRS resources are configured). The UE shall transmit PUSCH using the same antenna ports as the SRS port(s) in the SRS resource(s) indicated by SRI given by DCI.

In general, 5G NR includes a number of multi-input multi-output (MIMO) features that facilitate utilization of a large number of antenna elements at base station for both sub-6 GHz (Frequency Range 1, FR1) and over-6 GHz (Frequency Range 2, FR2) frequency bands, plus one of the MIMO features is that it supports for multi-TRP operation. One advantage of this functionality is to collaborate with multiple TRPs to transmit or receive data to the UE to improve transmission performance. As NR is in the process of commercialization, various aspects that require further enhancements can be identified from real deployment scenarios. According to the current evolution for 5G NR in 3GPP, simultaneous uplink transmissions can be supported and performed by multi-panel UE in MTRP operation, which is beneficial to improve the throughput of uplink transmission.

The following abbreviations are used throughout the present document.

| Acronym | Full Name |
|---|---|
| NR | New radio |
| UE | User equipment |
| NW | Network |
| TRP | Transmit receive point |
| PUSCH | Physical uplink shared channel |
| SRS | Sounding reference signal |
| DM-RS | Demodulation reference signal |
| RRC | Radio resource control |
| MAC CE | Medium access control control element |
| DCI | Downlink control information |
| TPMI | Transmission precoding matrix |
| | indication |
| SRI | SRS resource indicator |
| MSB | The most significant bit |
| LSB | The least significant bit |
| TCI | Transmission configuration indication |
| QCL | Quasi Co-location |

In some embodiments, a “simultaneous uplink transmission scheme” may be equivalent to multiple uplink transmissions can be fully or partially overlapped in time domain, where the simultaneous uplink transmissions can be associated with different panel/TRP ID, and these simultaneous uplink transmissions can be scheduled by a single DCI or multiple DCI. Beside, whether the UE supports the “simultaneous uplink transmission scheme” can be reported as the UE optional capability.

In various embodiments, a “TRP” may be equivalent to at least one of: SRS resource set, spatial relation, power control parameter set, TCI state, CORESET (e.g., a set of physical resources and a set of parameters characterizing a DCI transmission), CORESETPoolIndex, physical cell index (PCI), sub-array, CDM group of DMRS ports, the group of CSI-RS resources or CMR set.

In some embodiments, “UE panel” is equivalent to at least one of: UE capability value set, antenna group, antenna port group, beam group, sub-array, SRS resource set or panel mode.

Notes that, in this patent, the definition of “beam state” is equivalent to at least one of: quasi-co-location (QCL) state, transmission configuration indicator (TCI) state, spatial relation (also called as spatial relation information), reference signal (RS), spatial filter or precoding.

Furthermore, for compactness, in this document a “beam state” is also called as “beam.” Specifically,
A “Tx beam” may be equivalent to at least one of: QCL state, TCI state, spatial relation state, DL reference signal, UL reference signal, Tx spatial filter or Tx precoding;
A “Rx beam” may be equivalent to at least one of: QCL state, TCI state, spatial relation state, spatial filter, Rx spatial filter or Rx precoding;
A “beam ID” may be equivalent to at least one of: QCL state index, TCI state index, spatial relation state index, reference signal index, spatial filter index or precoding index.

Specifically, the spatial filter can be either UE-side or gNB-side one, and the spatial filter is also called as spatial-domain filter.

In some embodiments, a “spatial relation” is comprised of one or more reference signals (RSs), which is used to represent the same or quasi-co “spatial relation” between targeted “RS or channel” and the one or more reference RSs.

In some embodiments, a “spatial relation” may also mean at least one of: the beam, a spatial parameter or a spatial domain filter.

In some embodiments a “QCL state” is comprised of one or more reference RSs and their corresponding QCL type parameters, where QCL type parameters include at least one of the following aspect or combination: [1] Doppler spread, [2] Doppler shift, [3] delay spread, [4] average delay, [5] average gain, and [6] Spatial parameter (which is also called as spatial Rx parameter).

In some embodiments, a “TCI state” is equivalent to “QCL state”.

In some embodiments, ‘QCL-TypeA’, ‘QCL-TypeB’, ‘QCL-TypeC’, and ‘QCL-TypeD’ pay represent the following:
‘QCL-TypeA’: {Doppler shift, Doppler spread, average delay, delay spread}
‘QCL-TypeB’: {Doppler shift, Doppler spread}
‘QCL-TypeC’: {Doppler shift, average delay}
‘QCL-TypeD’: {Spatial Rx parameter}

In some embodiments, a RS comprises channel state information reference signal (CSI-RS), synchronization signal block (SSB) (which is also called as SS/PBCH), demodulation reference signal (DMRS), sounding reference signal (SRS), or a physical random access channel (PRACH). Furthermore, the RS may comprise DL reference signal and/or UL reference signaling.
A DL RS at least comprises CSI-RS, SSB, DMRS (e.g., DL DMRS);
A UL RS at least comprises SRS, DMRS (e.g., UL DMRS), and PRACH.

In some embodiments, a “UL signal” can be PUCCH, PUSCH, or SRS.

In some embodiments, a “DL signal” can be PDCCH, PDSCH, or CSI-RS.

In some embodiments, the first and the second SRS resource sets are respectively the ones with lower and higher srs-ResourceSetId of the two SRS resources sets configured by higher layer parameter srs-ResourceSetToAddModList or srs-ResourceSetToAddModListDCI-0-2, and associated with the higher layer parameter usage of value ‘nonCodeBook’ if txConfig=nonCodebook or ‘codeBook’ if xConfig=codebook.

In some embodiments, PUSCH repetition is equivalent to PUSCH transmission occasion.

### Example Embodiment #1

These embodiments may incorporate a precoder indication for CB and NCB based simultaneous PUSCH repetition in MTRP operation.

If at least one of the following conditions is satisfied,
1) The UE is scheduled to transmit more than one PUSCH repetition simultaneously, wherein the time domain of these PUSCH repetitions are fully or partially overlapped.
   a. Here, the PUSCH repetition can be at least one of: inter-slot based PUSCH repetition or intra-slot based PUSCH repetition.
   b. Here, these PUSCH repetitions are transmitted with same or different RV.
2) The one or more PUSCH repetitions are configured with one or more SRS resource sets, which are configured in srs-ResourceSetToAddModList or srs-ResourceSetToAddModListDCI-0-2 with higher layer parameter usage in SRS-ResourceSet set to ‘codebook’ or ‘nonCodebook’.
3) For codebook or non-codebook based transmission scheme, the PUSCH can be scheduled by DCI format 0_1, DCI format 0_2 or RRC signaling.
4) For these PUSCH repetitions transmitted simultaneously, each of PUSCH repetitions is associated with one SRS resource set.
5) These PUSCH repetitions are indicated with different beams or spatial relations.

The UE may gets and applies one or a plurality of precoding matrices to these PUSCH repetitions.
1) Wherein, the precoding matrix is used to indicate the precoder to be applied over the transmission layers.
2) Optionally, the plurality of precoding matrices are given by DCI indication or RRC signaling. In some embodiments, the DCI indication can be at least one of the DCI format 0_1 or DCI format 0_2, the RRC signaling can be at least one of the higher layer parameter precodingAndNumberOfLayers or the higher layer parameter precodingAndNumberOfLayers2-r17.
   a. In some embodiments, each of precoding matrices is separately indicated by a Precoding information and number of layers field in the DCI.
      a) In some embodiments, the overhead of each Precoding information and number of layers field of each precoding matrix depends on at least one of the following factors:
         i. Factor-1: the maximum transmission layers of the PUSCH repetition;
         i) For an example, the maximum transmission layers is determined by the higher layer parameter maxRank in PUSCH-Config of the PUSCH repetition.
         ii. Factor-2: the maximum number of the antenna ports of the PUSCH repetition;
         i) For an example, the maximum number of the antenna ports is determined by the higher layer parameter nrofSRS-Ports in SRS-Resource of the PUSCH repetition.
         iii. Factor-3: the maximum coherence capability of the antenna ports supported by the UE of the PUSCH repetition.
         i) For an example, the maximum coherence capabilities of the antenna ports is determined by the higher layer parameter codebookSubset in PUSCH-Config of the PUSCH repetition, whose value can be configured as at least one of: ‘fullyAndPartialAndNonCoherent’, ‘partialAndNonCoherent’ or ‘nonCoherent’.
      b) Optionally, the spatial phase coefficient of the precoding matrix of the PUSCH repetition is determined and indicated to the UE.
         i. Optionally, the spatial phase coefficient is a relative value between two precoding matrices of two PUSCH repetitions.
         ii. Optionally, the spatial phase coefficient is a absolute value of the precoding matrix of the PUSCH repetition.
         iii. Optionally, the spatial phase coefficient is indicated by the Precoding information and number of layers field.
         iv. Optionally, the spatial phase coefficient is indicated by a field in DCI exclusively.
         v. Optionally, the candidate values of the spatial phase coefficient comprise at least one of: 1, j, −1 or −j.
   b. In some embodiments, the plurality of precoding matrices are jointly indicated by a single Precoding information and number of layers field in the DCI.
      a) Optionally, each of the precoding matrices is indicated by different bits in the Precoding information and number of layers field.
         i. For an example, if the number of PUSCH repetitions is 2, MSB bits are used to indicate the first precoding matrix of the first PUSCH repetition and LSB bits are used to indicate the second precoding matrix of the second PUSCH repetition.
      b) Optionally, a mixed precoding matrix is indicated by the Precoding information and number of layers field.
         i. In some embodiments, the mixed precoding matrix is combined by the plurality of precoding matrices.
         i) In some embodiments, if each of these PUSCH repetitions is transmitted in different transmission layers or different frequency domains and associated with different DM-RS ports, the mixed precoding matrix is derived from one of the following method:
         a. Method-1: for an example, when the number of the PUSCH repetitions is 2, the mixed precoding matrix is derived from the following formula:

$${W}_{mixed} = [ \begin{matrix}{W}_{1} & 0 \\ 0 & {W}_{2}\end{matrix} ]$$

wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
b. Method-2: for an example, when the number of the PUSCH repetitions is 2, the mixed precoding matrix is derived from the following formula:

$${W}_{mixed} = [ \begin{matrix}{φ}_{1} {W}_{1} & 0 \\ 0 & {φ}_{2} {W}_{2}\end{matrix} ]$$

wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
φ₁ is the spatial phase coefficient of the first precoding matrix of the first PUSCH repetition.
φ₂ is the spatial phase coefficient of the second precoding matrix of the second PUSCH repetition.
c. Method-3: for an example, when the number of the PUSCH repetitions is 2, the mixed precoding matrix is derived from the following formula:

$${W}_{mixed} = [ \begin{matrix}{W}_{1} & 0 \\ 0 & Δφ {W}_{2}\end{matrix} ]$$

wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
Δφ is the relative spatial phase coefficient of the second precoding matrix of the second PUSCH repetition.
d. Method-4: for an example, when the number of the PUSCH repetitions is 2, the mixed precoding matrix is derived from the following formula:

$${W}_{mixed} = [ \begin{matrix}{W}_{11} & {W}_{12} \\ {W}_{21} & {W}_{22}\end{matrix} ]$$

wherein,
W_{mixed} is the mixed precoding matrix which combined by the plurality of precoding matrices.
W₁₁ is the first precoding matrix of the first PUSCH repetition.
W₂₂ is the second precoding matrix of the second PUSCH repetition.
W₁₂ is the precoding matrix of the interference between the transmission layers of the first and the second PUSCH repetitions.
W₂₁ is the second precoding matrix of the interference between the antenna ports of the first and the second PUSCH repetitions.
e. Method-5: for an example, when the number of the PUSCH repetitions is 2, the mixed precoding matrix is derived from the following formula:

$${W}_{mixed} = [ \begin{matrix}{φ}_{11} {W}_{11} & {W}_{12} \\ {W}_{21} & {φ}_{22} {W}_{22}\end{matrix} ]$$

wherein,
W_{mixed} is the mixed precoding matrix which combined by the plurality of precoding matrices.
W₁ is the first precoding matrix of the first PUSCH repetition.
W₂₂ is the second precoding matrix of the second PUSCH repetition.
W₁₂ is the precoding matrix of the interference between the transmission layers of the first and the second PUSCH repetitions.
W₂₁ is the precoding matrix of the interference between the antenna ports of the first and the second PUSCH repetitions.
φ₁ is the spatial phase coefficient of the first precoding matrix of the first PUSCH repetition.
φ₂₂ is the spatial phase coefficient of the second precoding matrix of the second PUSCH repetition.
f. Method-6: for an example, when the number of the PUSCH repetitions is 2, the mixed precoding matrix is derived from the following formula:

$${W}_{mixed} = [ \begin{matrix}{φ}_{11} {W}_{11} & {φ}_{12} {W}_{12} \\ {φ}_{22} {W}_{21} & {φ}_{22} {W}_{22}\end{matrix} ]$$

wherein,
W_{mixed} is the mixed precoding matrix which combined by the plurality of precoding matrices.
W₁₁ is the first precoding matrix of the first PUSCH repetition.
W₂₂ is the second precoding matrix of the second PUSCH repetition.
W₁₂ is the precoding matrix of the interference between the transmission layers of the first and the second PUSCH repetitions.
W₂₁ is the precoding matrix of the interference between the antenna ports of the first and the second PUSCH repetitions.
φ₁₁ is the spatial phase coefficient of the first precoding matrix of the first PUSCH repetition.
φ₂₂ is the spatial phase coefficient of the second precoding matrix of the second PUSCH repetition.
φ₁₂ is the spatial phase coefficient of the precoding matrix of the interference between the transmission layers of the first and the second PUSCH repetitions.
φ₂₁ is the spatial phase coefficient of the precoding matrix of the interference between the antenna ports of the first and the second PUSCH repetitions.
g. Method-7: for an example, when the number of the PUSCH repetitions is 2, the mixed precoding matrix is derived from the following formula:

$${W}_{mixed} = [ \begin{matrix}{W}_{11} & {Δφ}_{1} {W}_{12} \\ {Δφ}_{2} {W}_{21} & Δφ {W}_{22}\end{matrix} ]$$

wherein,
W_{mixed} is the mixed precoding matrix which combined by the plurality of precoding matrices.
W₁₁ is the first precoding matrix of the first PUSCH repetition.
W₂₂ is the second precoding matrix of the second PUSCH repetition.
W₁₂ is the precoding matrix of the interference between the transmission layers of the first and the second PUSCH repetitions.
W₂₁ is the precoding matrix of the interference between the antenna ports of the first and the second PUSCH repetitions.
Δφ is the relative spatial phase coefficient of the second precoding matrix of the second PUSCH repetition.
Δφ₁ is the relative spatial phase coefficient of the precoding matrix of the interference between the transmission layers of the first and the second PUSCH repetitions.
Δφ₂ is the relative spatial phase coefficient of the precoding matrix of the interference between the antenna ports of the first and the second PUSCH repetitions.
h. Method-8: for an example, when the number of the PUSCH repetitions is 2, the mixed precoding matrix is derived from the following formula:

W_{mixed}=[W₁ W₂]
wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
i. Method-9: for an example, when the number of the PUSCH repetitions is 2, the mixed precoding matrix is derived from the following formula:

W_{mixed}=[φ₁W₁ φ₂W₂]
wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
φ₁ is the spatial phase coefficient of the first precoding matrix of the first PUSCH repetition.
φ₂ is the spatial phase coefficient of the second precoding matrix of the second PUSCH repetition.
j. Method-10: for an example, when the number of the PUSCH repetitions is 2, the mixed precoding matrix is derived from the following formula:

W_{mixed}=[W₁ ΔφW₂]
wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
Δφ is the relative spatial phase coefficient of the second precoding matrix of the second PUSCH repetition.
ii) In some embodiments, if each of these PUSCH repetitions is transmitted in same transmission layers and associated with same DM-RS port(s), the mixed precoding matrix is derived from one of the following method:
a. Method-1: for an example, when the number of the PUSCH repetitions is 2, the mixed precoding matrix is derived from the following formula:

$${W}_{mixed} = [ \begin{matrix}{W}_{1} \\ {W}_{2}\end{matrix} ]$$

wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
b. Method-2: for an example, when the number of the PUSCH repetitions is 2, the mixed precoding matrix is derived from the following formula:

$${W}_{mixed} = [ \begin{matrix}{φ}_{1} {W}_{1} \\ {φ}_{2} {W}_{2}\end{matrix} ]$$

wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
φ₁ is the spatial phase coefficient of the first precoding matrix of the first PUSCH repetition.
φ₂ is the spatial phase coefficient of the second precoding matrix of the second PUSCH repetition.
c. Method-3: for an example, when the number of the PUSCH repetitions is 2, the mixed precoding matrix is derived from the following formula:

$${W}_{mixed} = [ \begin{matrix}{W}_{1} \\ Δφ {W}_{2}\end{matrix} ]$$

wherein,
W_{mixed} is the mixed precoding matrix which combined by the plurality of precoding matrices.
W₁ is the first precoding matrix of the first PUSCH repetition.
W₂ is the second precoding matrix of the second PUSCH repetition.
Δφ is the relative spatial phase coefficient of the second precoding matrix of the second PUSCH repetition.
c. In some embodiments, the number of the antenna ports of the precoding matrix of the PUSCH repetition satisfies at least one of the following requisites:
   a) Optionally, the number of antenna ports of each PUSCH repetition can be the same or different.
   b) Optionally, the number of antenna ports of each PUSCH repetition can be at least one of: 1, 2 or 4.
   c) Optionally, if the number of all PUSCH repetitions is two, the port combinations of the two PUSCH repetitions comprise at least one of: {1 port, 1 port}, {1 port, 2 ports}, {2 ports, 2 ports}, {1 port, 4 ports}, {2 ports, 4 ports} or {4 ports, 4 ports}. In some embodiments, each value of the combination is associated with an SRS resource set of the PUSCH repetition. For example, the first and second values are associated with the first and second SRS resource sets, respectively.
   d) Optionally, the maximum number of antenna ports of each SRS resource of each PUSCH repetition is configured by the higher layer signaling nrofSRS-Ports in SRS-Config, where the candidate values of nrofSRS-Ports of each SRS resource of each PUSCH repetition comprise at least one of: 1 port, 2 ports or 4 ports.
d. In some embodiments, the number of transmission layers of the precoding matrix of the PUSCH repetitions satisfies at least one of the following requisites:
   a) Optionally, the number of transmission layers of each PUSCH repetition is the same.
   b) Optionally, the maximum number of transmission layers of all PUSCH repetitions should be equal to 2 or 4.
      i. In some embodiments, the number of transmission layers of each PUSCH repetition can be 1 or 2.
   c) Optionally, if the number of all PUSCH repetitions is two, the transmission layer combinations of the all PUSCH repetition comprise at least one of: {1 layer, 1 layer} or {2 layers, 2 layers}. In some embodiments, each value of the combination is associated with an SRS resource set, for example, the first and second values are associated with the first and second SRS resource sets, respectively.
   d) Optionally, the maximum number of transmission layers of each SRS resource set of each PUSCH repetition is separately configured by the higher layer signaling maxRank in pusch-Config, where the candidate values of maxRank of each SRS resources set of each PUSCH repetition comprise at least one of: 1 or 2.
      i. Further, if the number of all PUSCH repetition is two, the candidate value combinations of maxRank can be at least one of: {1, 1} or {2, 2}. In some embodiments, each value of the combination is associated with an SRS resource set, for example, the first and second values are associated with the first and second SRS resource sets, respectively.
   e) Optionally, the maximum number of transmission layers of all PUSCH repetitions which are associated with one or a plurality of SRS resource sets is jointly configured by the higher layer signaling maxRank in pusch-Config, where the candidate values of maxRank comprise at least one of: 2 or 4.
      i. Further, the maximum number of transmission layers of each SRS resource set of each PUSCH repetition is equal to the configured value of maxRank in pusch-Config divided by the number of SRS resource sets which associated with all PUSCH repetitions. For example, if the configured value of maxRank in pusch-Config is 2 and the total number of SRS resource sets is 2, the maximum number of transmission layers of each PUSCH repetition is equal to 1. If the configured value of maxRank in pusch-Config is 4 and the total number of SRS resource sets is 2, the maximum number of transmission layers of each PUSCH repetition is equal to 2.
e. In some embodiments, if the transmission layers of each PUSCH repetition is different, the mapping between the transmission layers and the antenna ports of each PUSCH repetitions is basically determined by the indicated precoding matrix(es). Further, for non-codebook based transmission, the precoding matrix equals the identity matrix; For codebook based transmission, the precoding matrix W is given by W=1 for single-layer transmission on a single antenna port, otherwise by TPMI index obtained from the DCI which scheduling the uplink transmission or the higher layer parameters (e.g., precodingAndNumberOfLayers).
   a) Optionally, the determination of the mapping is based on at least one of the following components:
      i. Component-1: the indices of the antenna ports of each PUSCH repetition are separately ordered according to the indicated SRS resource for the PUSCH repetition. For example, PUSCH repetition 1 is associated with 2-port SRS resource 1 and PUSCH repetition 2 is associated with 4-port SRS resource 2, then the indices of the antenna ports of PUSCH repetition 1 are 0 to 1 and the indices of the antenna ports of PUSCH repetition 2 are 0 to 3. Further, the antenna ports of PUSCH repetition 1 are {p₀,p₁} and the antenna ports of PUSCH repetition 2 are {p₀,p₁,p₂,p₃}. Besides, antenna ports starting with index=1000 are defined and used for PUSCH.
      ii. Component-2: the indices of the transmission layers of each PUSCH repetition are separately ordered according to the indicated or configured transmission layers (e.g., indicated by TPMI field, configured by the higher layer parameter precodingAndNumberOfLayers or the higher layer parameter maxRank) for the PUSCH repetition. For example, the indicated transmission layer of PUSCH repetition 1 is 1 and the indicated transmission layers of PUSCH repetition 2 are 2, then the index of the transmission layer of PUSCH repetition 1 is 0 and the indices of the transmission layers of PUSCH repetition 2 are 0 to 1. Further, the transmission layer of PUSCH repetition 1 is {v₀} and the transmission layers of PUSCH repetition 2 are {v₀,v₁}.
      iii. Component-3: the indicated precoding matrix is used for the mapping of each PUSCH repetition.
      iv. Component-4: the signals of the first PUSCH repetition on antenna ports in the set [0, . . . , v₁−1] for v₁ layers would result in signals equivalent to corresponding symbols transmitted on antenna ports [0, . . . , P₁−1] according to the indicated SRS resource of the first PUSCH repetition, and the signals of the second PUSCH repetition on antenna ports in the set [0, . . . , v₂−1] for v₂ layers would result in signals equivalent to corresponding symbols transmitted on antenna ports [0, . . . , P₂−1] according to the indicated SRS resource of the second PUSCH repetition, and so on. The following formula further explains the above mapping:

$$[ \begin{matrix}{z}_{j}^{( {p}_{0} )} ( i ) \\ ⋮ \\ {z}_{j}^{( {p}_{{ρ}_{j} - 1} )} ( i )\end{matrix} ] = {W}_{j} [ \begin{matrix}{y}_{j}^{( 0 )} ( i ) \\ ⋮ \\ {y}_{j}^{( {v}_{j} - 1 )} ( i )\end{matrix} ]$$

wherein,
j=1, . . . , n are associated with up to n PUSCH repetitions. For example, j=1 is associated with the first PUSCH repetition, j=2 is associated with the second PUSCH repetition, and so on. Besides, n denotes the total number of PUSCH repetitions, and n>1;
[zⱼ^{(p}^{₀}⁾(i) . . . zⱼ^{(p(p}^{ⱼ}⁻¹⁾⁾(i)]^{T} denotes the block of complex-valued symbols of the antenna port(s) used for the j-th PUSCH repetition. In some embodiments, p denotes the antenna port(s) used for the j-th PUSCH repetition, p denotes the number of the antenna port(s) used for the j-th PUSCH repetition;
[yⱼ⁽⁰⁾(i) . . . yⱼ^{(v}^{ⱼ}⁻¹⁾(i)]^{T} denotes the block of complex-valued symbols of the transmission layer(s) used for the j-th PUSCH repetition. Wherein, v denotes the number of transmission layer(s) used for the j-th PUSCH repetition;
Wⱼ denotes the indicated precoding matrix used for the j-th PUSCH repetition;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
b) Optionally, the determination of the mapping is based on at least one of the following components:
   i. Component-1: the indices of the antenna ports of each PUSCH repetition are separately ordered according to the indicated SRS resource for the PUSCH repetition. For example, PUSCH repetition 1 is associated with 2-port SRS resource 1 and PUSCH repetition 2 is associated with 4-port SRS resource 2, then the indices of the antenna ports of PUSCH repetition 1 are 0 to 1 and the the indices of the antenna ports of PUSCH repetition 2 are 0 to 3. Further, the antenna ports of PUSCH repetition 1 are {p₀,p₁} and the antenna ports of PUSCH repetition 2 are {p₀,p₁,p₂,p₃}. Besides, antenna ports starting with index=1000 are defined and used for PUSCH.
   ii. Component-2: the indices of the transmission layers of all PUSCH repetitions are jointly ordered according to the indicated or configured transmission layers (e.g., indicated by TPMI field, configured by the higher layer parameter precodingAndNumberOfLayers or the higher layer parameter maxRank) for these PUSCH repetitions. For example, the indicated transmission layer of PUSCH repetition 1 is 1 and the indicated transmission layers of PUSCH repetition 2 are 2, then the index of the transmission layer of PUSCH repetition 1 is 0 and the indices of the transmission layers of PUSCH repetition 2 are 1 to 2. Further, the transmission layer of PUSCH repetition 1 is {v₀} and the transmission layers of PUSCH repetition 2 are {v₁,v₂}.
   iii. Component-3: the indicated precoding matrix is used for the mapping of each PUSCH repetition.
   iv. Component-4: the signals of the first PUSCH repetition on antenna ports in the set [0, . . . , v₁−1] for v₁ layers would result in signals equivalent to corresponding symbols transmitted on antenna ports [0, . . . , P₁−1] according to the indicated SRS resource of the first PUSCH repetition, and the signals of the second PUSCH repetition on antenna ports in the set [v₁, . . . , v₁+v₂−1] for v₂ layers would result in signals equivalent to corresponding symbols transmitted on antenna ports [0, . . . , P₂−1] according to the indicated SRS resource of the second PUSCH repetition, and so on. The following formula further explains the above mapping:

$$[ \begin{matrix}{z}_{j}^{( {p}_{0} )} ( i ) \\ ⋮ \\ {z}_{j}^{( {p}_{{ρ}_{j} - 1} )} ( i )\end{matrix} ] = {W}_{j} [ \begin{matrix}{y}^{( {\sum }_{j = 1}^{n - 1} {v}_{j} )} ( i ) \\ ⋮ \\ {y}^{( ( {\sum }_{j = 1}^{n} {v}_{j} ) - 1 )} ( i )\end{matrix} ] , n > 1 ;$$

wherein,
n denotes the total number of PUSCH repetitions, and n>1;
j=1, . . . , n are associated with up to n PUSCH repetitions. For example, j=1 is associated with the first PUSCH repetition, j=2 is associated with the second PUSCH repetition, and so on;
[zⱼ^{(p}^{₀}⁾(i) . . . z₁^{(p(p}^{ⱼ}⁻¹⁾⁾(i)]^{T} denotes the block of complex-valued symbols of the antenna port(s) used for the j-th PUSCH repetition. Wherein, p denotes the antenna port(s) used for the j-th PUSCH repetition, p denotes the number of the antenna port(s) used for the j-th PUSCH repetition;

$${[ {y}^{( {\sum }_{j = 1}^{n - 1} {v}_{j} )} ( i ) … {y}^{( ( {\sum }_{j = 1}^{n} {v}_{j} ) - 1 )} ( i ) ]}^{T}$$

denotes the block of complex-valued symbols of the transmission layer(s) used for the j-th PUSCH repetition. Wherein, v denotes the number of transmission layer(s) used for the j-th PUSCH repetition;
Wⱼ denotes the indicated precoding matrix used for the j-th PUSCH repetition;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
c) Optionally, the determination of the mapping is based on at least one of the following components:
   i) Component-1: the indices of the antenna ports of each PUSCH repetition are jointly ordered according to the indicated SRS resources for these PUSCH repetitions. For example, PUSCH repetition 1 is associated with 2-port SRS resource 1 and PUSCH repetition 2 is associated with 4-port SRS resource 2, then the indices of the antenna ports of PUSCH repetition 1 are 0 to 1 and the the indices of the antenna ports of PUSCH repetition 2 are 2 to 5. Further, the antenna ports of PUSCH repetition 1 are {p₀,p₁} and the antenna ports of PUSCH repetition 2 are {p₂, p₃, p₄, p₅}. Besides, antenna ports starting with index=1000 are defined and used for PUSCH.
   ii) Component-2: the indices of the transmission layers of each PUSCH repetition are separately ordered according to the indicated or configured transmission layers (e.g., indicated by TPMI field, configured by the higher layer parameter precodingAndNumberOfLayers or the higher layer parameter maxRank) for the PUSCH repetition. For example, the indicated transmission layer of PUSCH repetition 1 is 1 and the indicated transmission layers of PUSCH repetition 2 are 2, then the index of the transmission layer of PUSCH repetition 1 is 0 and the indices of the transmission layers of PUSCH repetition 2 are 0 to 1. Further, the transmission layer of PUSCH repetition 1 is {v₀} and the transmission layers of PUSCH repetition 2 are {v₀,v₁}
   iii) Component-3: the indicated precoding matrix is used for the mapping of each PUSCH repetition.
   iv) Component-4: the signals of the first PUSCH repetition on antenna ports in the set [0, . . . , v₁−1] for v₁ layers would result in signals equivalent to corresponding symbols transmitted on antenna ports [0, . . . , P₁−1] according to the indicated SRS resource of the first PUSCH repetition, and the signals of the second PUSCH repetition on antenna ports in the set [0, . . . , v₂−1] for v₂ layers would result in signals equivalent to corresponding symbols transmitted on antenna ports [P₁, . . . , P₁+P₂−1] according to the indicated SRS resource of the second PUSCH repetition, and so on. The following formula further explains the above mapping:

$$[ \begin{matrix}{z}^{{( p}^{} {( {\sum }_{j = 1}^{n - 1} {ρ}_{j} )}^{)}} ( i ) \\ ⋮ \\ {z}^{{( p}^{} {( {( {\sum }_{j = 1}^{n} {ρ}_{j} )}^{- 1} )}^{)}} ( i )\end{matrix} ] = {W}_{j} [ \begin{matrix}{y}_{j}^{( 0 )} ( i ) \\ ⋮ \\ {y}_{j}^{( {v}_{j} - 1 )} ( i )\end{matrix} ] , n > 1 ;$$

wherein,
n denotes the total number of PUSCH repetitions, and n>1;
j=1, . . . , n are associated with up to n PUSCH repetitions. For example, j=1 is associated with the first PUSCH repetition, j=2 is associated with the second PUSCH repetition, and so on;
[z^{(p}^{₀}⁾(i) . . . z^{(p(p}^{ⱼ}⁻¹⁾⁾(i)]^{T} denotes the block of complex-valued symbols of the antenna port(s) used for the j-th PUSCH repetition. Wherein, p denotes the antenna port(s) used for the j-th PUSCH repetition, p denotes the number of the antenna port(s) used for the j-th PUSCH repetition;

$${[ {{y}_{j}}^{( {\sum }_{j = 1}^{n - 1} {v}_{j} )} ( i ) … {{y}_{j}}^{( ( {\sum }_{j = 1}^{n} {v}_{j} ) - 1 )} ( i ) ]}^{T}$$

denotes the block of complex-valued symbols of the transmission layer(s) used for the j-th PUSCH repetition. Wherein, v denotes the number of transmission layer(s) used for the j-th PUSCH repetition;
Wⱼ denotes the indicated precoding matrix used for the j-th PUSCH repetition;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
d) Optionally, the determination of the mapping is based on at least one of the following components:
   i. Component-1: the indices of the antenna ports of each PUSCH repetition are jointly ordered according to the indicated SRS resources for these PUSCH repetitions. For example, PUSCH repetition 1 is associated with 2-port SRS resource 1 and PUSCH repetition 2 is associated with 4-port SRS resource 2, then the indices of the antenna ports of PUSCH repetition 1 are 0 to 1 and the the indices of the antenna ports of PUSCH repetition 2 are 2 to 5. Further, the antenna ports of PUSCH repetition 1 are {p₀,p₁} and the antenna ports of PUSCH repetition 2 are {p₂, p₃,p₄,p₅}. Besides, antenna ports starting with index=1000 are defined and used for PUSCH.
   ii. Component-2: the indices of the transmission layers of all PUSCH repetitions are jointly ordered according to the indicated or configured transmission layers (e.g., indicated by TPMI field, configured by the higher layer parameter precodingAndNumberOfLayers or the higher layer parameter maxRank) for these PUSCH repetitions. For example, the indicated transmission layer of PUSCH repetition 1 is 1 and the indicated transmission layers of PUSCH repetition 2 are 2, then the index of the transmission layer of PUSCH repetition 1 is 0 and the indices of the transmission layers of PUSCH repetition 2 are 1 to 2. Further, the transmission layer of PUSCH repetition 1 is {v₀} and the transmission layers of PUSCH repetition 2 are {v₁,v₂}.
   iii. Component-3: the indicated precoding matrix is used for the mapping of each PUSCH repetition.
   iv. Component-4: the signals of the first PUSCH repetition on antenna ports in the set [0, . . . , v₁−1] for v₁ layers would result in signals equivalent to corresponding symbols transmitted on antenna ports [0, . . . , P₁−1] according to the indicated SRS resource of the first PUSCH repetition, and the signals of the second PUSCH repetition on antenna ports in the set [v₁, . . . , v₁+v₂−1] for v₂ layers would result in signals equivalent to corresponding symbols transmitted on antenna ports [P₁, . . . , P₁+P₂−1] according to the indicated SRS resource of the second PUSCH repetition, and so on. The following formula further explains the above mapping:

$$[ \begin{matrix}{z}^{{( p}^{} {( {\sum }_{j = 1}^{n - 1} {ρ}_{j} )}^{)}} ( i ) \\ ⋮ \\ {z}^{{( p}^{} {( ( {\sum }_{j = 1}^{n} {ρ}_{j} ) - 1 )}^{)}} ( i )\end{matrix} ] = W [ \begin{matrix}{y}^{( {\sum }_{j = 1}^{n - 1} {v}_{j} )} ( i ) \\ ⋮ \\ {y}^{( ( {\sum }_{j = 1}^{n} {v}_{j} ) - 1 )} ( i )\end{matrix} ] , n > 1 ;$$

wherein,
n denotes the total number of PUSCH repetitions, and n>1;
j=1, . . . , n are associated with up to n PUSCH repetitions. For example, j=1 is associated with the first PUSCH repetition, j=2 is associated with the second PUSCH repetition, and so on;

$${[ {z}^{{( p}^{} {( {\sum }_{j = 1}^{n - 1} {ρ}_{j} )}^{)}} ( i ) … {z}^{{( p}^{} {( {( {\sum }_{j = 1}^{n} {ρ}_{j} )}^{- 1} )}^{)}} ( i ) ]}^{T}$$

denotes the block of complex-valued symbols of the antenna port(s) used for the j-th PUSCH repetition. Wherein, p denotes the antenna port(s) used for the j-th PUSCH repetition, p denotes the number of the antenna port(s) used for the j-th PUSCH repetition;

$${[ {y}^{( {\sum }_{j = 1}^{n - 1} {v}_{j} )} ( i ) … {y}^{( ( {\sum }_{j = 1}^{n} {v}_{j} ) - 1 )} ( i ) ]}^{T}$$

denotes the block of complex-valued symbols of the transmission layer(s) used for the j-th PUSCH repetition. Wherein, v denotes the number of transmission layer(s) used for the j-th PUSCH repetition;
Wⱼ denotes the indicated precoding matrix used for the j-th PUSCH repetition;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
e) Optionally, the determination of the mapping is based on at least one of the following components:
   i. Component-1: the indices of the antenna ports of each PUSCH repetition are jointly ordered according to the indicated SRS resources for these PUSCH repetitions. For example, PUSCH repetition 1 is associated with 2-port SRS resource 1 and PUSCH repetition 2 is associated with 4-port SRS resource 2, then the indices of the antenna ports of PUSCH repetition 1 are 0 to 1 and the the indices of the antenna ports of PUSCH repetition 2 are 2 to 5. Further, the antenna ports of PUSCH repetition 1 are {p₀,p₁} and the antenna ports of PUSCH repetition 2 are {p₂,p₃,p₄,p₅}. Besides, antenna ports starting with index=1000 are defined and used for PUSCH.
   ii. Component-2: the indices of the transmission layers of all PUSCH repetitions are jointly ordered according to the indicated or configured transmission layers (e.g., indicated by TPMI field, configured by the higher layer parameter precodingAndNumberOfLayers or the higher layer parameter maxRank) for these PUSCH repetitions. For example, the indicated transmission layer of PUSCH repetition 1 is 1 and the indicated transmission layers of PUSCH repetition 2 are 2, then the index of the transmission layer of PUSCH repetition 1 is 0 and the indices of the transmission layers of PUSCH repetition 2 are 1 to 2. Further, the transmission layer of PUSCH repetition 1 is {v₀} and the transmission layers of PUSCH repetition 2 are {v₁,v₂}.
   iii. Component-3: the indicated precoding matrix is used for the mapping of each PUSCH repetition.
   iv. Component-4: the signals of the first PUSCH repetition on antenna ports in the set [0, . . . , v₁−1] for v₁ layers would result in signals equivalent to corresponding symbols transmitted on antenna ports [0, . . . , P₁−1] according to the indicated SRS resource of the first PUSCH repetition, and the signals of the second PUSCH repetition on antenna ports in the set [v₁, . . . , v₁+v₂−1] for v₂ layers would result in signals equivalent to corresponding symbols transmitted on antenna ports [P₁, . . . , P₁+P₂−1] according to the indicated SRS resource of the second PUSCH repetition, and so on. The following formula further explains the above mapping:

$$[ \begin{matrix}[ \begin{matrix}{z}^{( {p}_{0} )} ( i ) \\ ⋮ \\ {z}^{( {p}_{{ρ}_{1} - 1} )} ( i )\end{matrix} ] \\ ⋮ \\ [ \begin{matrix}{z}^{{( p}^{} {( {\sum }_{j = 1}^{n - 1} {ρ}_{j} )}^{)}} ( i ) \\ ⋮ \\ {z}^{{( p}^{} {( ( {\sum }_{j = 1}^{n} {ρ}_{j} ) - 1 )}^{)}} ( i )\end{matrix} ]\end{matrix} ] = [ \begin{matrix}{W}_{1} & & \\ & ⋱ & \\ & & {W}_{j}\end{matrix} ] \times [ \begin{matrix}\begin{matrix}{y}^{( 0 )} ( i ) \\ ⋮ \\ {y}^{( v - 1 )} ( i )\end{matrix} \\ ⋮ \\ \begin{matrix}{y}^{( {\sum }_{j = 1}^{n - 1} {v}_{j} )} ( i ) \\ ⋮ \\ {y}^{( ( {\sum }_{j = 1}^{n} {v}_{j} ) - 1 )} ( i )\end{matrix}\end{matrix} ] , n > 1 ;$$

wherein,
n denotes the total number of PUSCH repetitions, and n>1;
j=1, . . . , n are associated with up to n PUSCH repetitions. For example, j=1 is associated with the first PUSCH repetition, j=2 is associated with the second PUSCH repetition, and so on;

$${[ {z}^{{( p}^{} {( {\sum }_{j = 1}^{n - 1} {ρ}_{j} )}^{)}} ( i ) … {z}^{{( p}^{} {( {( {\sum }_{j = 1}^{n} {ρ}_{j} )}^{- 1} )}^{)}} ( i ) ]}^{T}$$

denotes the block of complex-valued symbols of the antenna port(s) used for the j-th PUSCH repetition. Wherein, p denotes the antenna port(s) used for the j-th PUSCH repetition, p denotes the number of the antenna port(s) used for the j-th PUSCH repetition;

$${[ {y}^{( {\sum }_{j = 1}^{n - 1} {v}_{j} )} ( i ) … {y}^{( ( {\sum }_{j = 1}^{n} {v}_{j} ) - 1 )} ( i ) ]}^{T}$$

denotes the block of complex-valued symbols of the transmission layer(s) used for the j-th PUSCH repetition. Wherein, v denotes the number of transmission layer(s) used for the j-th PUSCH repetition;
Wⱼ denotes the indicated precoding matrix used for the j-th PUSCH repetition;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
f. Here, the power ratio of the precoding matrix of the PUSCH repetition satisfies at least one of the following requisites: In some examples, the power ratio may be determined by the base station (network side). For example, the procedure described in 3GPP TS 38.213 Section 7.1 may be used where s is the ratio of a number of antenna ports with non-zero PUSCH transmission power over the maximum number of SRS ports supported by the UE in one SRS resource.
   a) Further, the higher layer parameter txConfig in PUSCH-Config of each PUSCH repetition is set to ‘codebook’;
   b) Further, the UE first calculates a linear value of the total transmit power of all these PUSCH repetitions which would be transmitted simultaneously, and the UE scales (e.g., scales down) the linear value by the power ratio;
   c) Optionally, the power ratio of one PUSCH repetitions is determined or calculated by the following formula:

$$s = \frac{1}{{N}_{rep}} \times \frac{{N}_{{p}_{nz}}}{{N}_{{P}_{max}}}$$

Wherein,
s denotes the power ratio;
Nᵣₑₚ denotes the total number of PUSCH repetitions which would be transmitted simultaneously; Optionally, Nᵣₑₚ is equivalent to the total number of SRS resources sets which associated with all these PUSCH repetitions;
N_{P}_{_{nz}} denotes the number of antenna ports with non-zero transmission power of the PUSCH repetition and which may be indicated by the precoding matrix of the PUSCH repetition;
N_{P}_{ₘₐₓ} denotes the maximum number of SRS ports supported by the UE in one SRS resource within one SRS resource set, wherein the SRS resource set is associated with the PUSCH repetition.
d) Optionally, the power ratio of one PUSCH repetitions is determined or calculated by the following formula:

$$s = \frac{{N}_{{P}_{max}}}{{\sum }_{i = 1}^{n} {N}_{{P}_{max , i}}} \times \frac{{N}_{{P}_{nz}}}{{N}_{{P}_{max}}}$$

Wherein,
s denotes the power ratio;
N_{P}_{ₘₐₓ} denotes the maximum number of SRS ports supported by the UE in one SRS resource within one SRS resource set, wherein the SRS resource set is associated with the PUSCH repetition.
N_{P}_{_{max,i}} denotes the maximum number of SRS ports supported by the UE in one SRS resource within one SRS resource set, wherein the SRS resource set is associated with the i-th PUSCH repetition.
n denotes the total number of all these PUSCH repetition which would be transmitted simultaneously;
i=1, . . . , n and is associated with up to n PUSCH repetitions one by one. For example, i=1 is associated with the first PUSCH repetition, i=2 is associated with the second PUSCH repetition, and so on;
N_{P}_{_{nz}} denotes the number of antenna ports with non-zero transmission power of the PUSCH repetition and which may be indicated by the precoding matrix of the PUSCH repetition.
e) Optionally, the power ratio of one PUSCH repetitions is determined or calculated by the following formula:

$$s = \frac{{N}_{{p}_{nz}}}{{\sum }_{i = 1}^{n} {N}_{{p}_{nz , i}}}$$

Wherein,
s denotes the power ratio;
N_{P}_{_{nz}} denotes the number of antenna ports with non-zero transmission power of the PUSCH repetition and which may be indicated by the precoding matrix of the PUSCH repetition;
N_{P}_{_{nz,i}} denotes the number of antenna ports with non-zero transmission power of the i-th PUSCH repetition and which may be indicated by the precoding matrix of the i-th PUSCH repetition;
n denotes the total number of all these PUSCH repetition which would be transmitted simultaneously;
i=1, . . . , n and is associated with up to n PUSCH repetitions one by one. For example, i=1 is associated with the first PUSCH repetition, i=2 is associated with the second PUSCH repetition, and so on;
g. In some embodiments, if these PUSCH repetitions are scheduled by DCI format 0_1 or DCI format 0_2, the UE determines the precoder(s) of each PUSCH repetition upon TPMI(s) which indicated by Precoding information and number of layers field(s) in DCI if the number of antenna ports of the PUSCH repetition is more than 1.
   a) Further, the candidates of TPMI which indicated by the Precoding information and number of layers field are dedicated to different cases:
      i. In some embodiments, if the number of the PUSCH repetitions is 2, the maximum number of transmission layers of each PUSCH repetition is 2, and the maximum number of antenna ports of each PUSCH repetition is 4:
      i) Optionally, the bit size of the first Precoding information and number of layers field is 4, 5, or 6 bits according to the configured value of the maximum coherence capability of the antenna ports. Further, the TPMI candidates indicated by the first Precoding information and number of layers field are included in Table 1-1.

TABLE 1-1
TPMI candidates indicated by the first Precoding information and number
of layers field in the case of antenna ports = 4, maximum transmission
layers = 2 of PUSCH when simultaneous PUSCH repetition scheme

| Bit | | Bit | | Bit | |
|---|---|---|---|---|---|
| field | | field | | field | |
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 1 layer: TPMI = 4 | 10 | 1 layer: TPMI = 4 | 10-15 | reserved |
| . . . | . . . | . . . | . . . | | |
| 17 | 1 layer: TPMI = 11 | 17 | 1 layer: TPMI = 11 | | |
| 18 | 2 layers: TPMI = 6 | 20 | 2 layers: TPMI = 6 | | |
| . . . | . . . | . . . | . . . | | |
| 25 | 2 layers: TPMI = 13 | 25 | 2 layers: TPMI = 13 | | |
| 26 | 1 layers: TPMI = 12 | 26-31 | reserved | | |
| . . . | . . . | | | | |
| 41 | 1 layers: TPMI = 27 | | | | |
| 42 | 2 layers: TPMI = 14 | | | | |
| . . . | . . . | | | | |
| 49 | 2 layers: TPMI = 21 | | | | |
| 50-63 | reserved | | | | |

ii) Optionally, the bit size of the second Precoding information and number of layers field is 3, 4, or 5 bits according to the number of transmission layers indicated by the first Precoding information and number of layers field and the configured value of the maximum coherence capability of the antenna ports, if the maximum number of transmission layers of each PUSCH repetition is 2 and the maximum number of antenna ports of each PUSCH repetition is 4. Further, the TPMI candidates indicated by the second Precoding information and number of layers field are shown in Table 1-2.

TABLE 1-2
TPMI candidates indicated by the second Precoding information and number
of layers field in the case of antenna ports = 4, maximum transmission
layers = 2 of PUSCH when simultaneous PUSCH repetition scheme

| Bit | | Bit | | Bit | |
|---|---|---|---|---|---|
| field | | field | | field | |
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| . . . | . . . | . . . | . . . | . . . | . . . |
| 27 | 1 layer: TPMI = 27 | 11 | 1 layer: TPMI = 11 | 3 | 1 layer: TPMI = 3 |
| 28-31 | 1 layer: reserved | 12-15 | 1 layer: reserved | 4-7 | 1 layer: reserved |
| 0 | 2 layers: TPMI = 0 | 0 | 2 layers: TPMI = 0 | 0 | 2 layers: TPMI = 0 |
| . . . | . . . | . . . | . . . | . . . | . . . |
| 21 | 2 layers: TPMI = 21 | 13 | 2 layers: TPMI = 13 | 5 | 2 layers: TPMI = 5 |
| 22-31 | 2 layers: reserved | 14-15 | 2 layers: reserved | 6-7 | 2 layers: reserved |

iii) Optionally, the bit size and the TPMI candidates of the second Precoding information and number of layers field is the same as the first Precoding information and number of layers field.
ii. In some embodiments, if the number of the PUSCH repetitions is 2, the maximum number of transmission layers of each PUSCH repetition is 1, and the maximum number of antenna ports of each PUSCH repetition is 4:
i) Optionally, the bit size of the first Precoding information and number of layers field is 2, 4, or 5 bits according to the configured value of the maximum coherence capability of the antenna ports. Further, the TPMI candidates indicated by the first Precoding information and number of layers field are included in Table 2-1.

TABLE 2-1
TPMI candidates indicated by the first Precoding information and number
of layers field in the case of antenna ports = 4, maximum transmission
layers = 1 of PUSCH when simultaneous PUSCH repetition scheme

| Bit | | Bit | | Bit | |
|---|---|---|---|---|---|
| field | | field | | field | |
| mapped | codebookSubset = | mapped | codebookSubset = | mapped | codebookSubset = |
| to index | fullyAndPartialAndNonCoherent | to index | partialAndNonCoherent | to index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layers: TPMI = 12 | 12-15 | reserved | | |
| . . . | . . . | | | | |
| 27 | 1 layers: TPMI = 27 | | | | |
| 28-31 | reserved | | | | |

ii) Optionally, the bit size and the TPMI candidates of the second Precoding information and number of layers field is the same as the first Precoding information and number of layers field.
iii. In some embodiments, if the number of the PUSCH repetitions is 2, the maximum number of transmission layers of each PUSCH repetition is 2, and the maximum number of antenna ports of each PUSCH repetition is 2:
i) Optionally, the bit size of the first Precoding information and number of layers field is 2 or 4 bits according to the configured value of the maximum coherence capability of the antenna ports. Further, the TPMI candidates indicated by the first Precoding information and number of layers field are included in Table 3-1.

TABLE 3-1
TPMI candidates indicated by the first Precoding information
and number of layers field in the case of antenna
ports = 2, maximum transmission layers =
2 of PUSCH when simultaneous PUSCH repetition scheme

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

ii) Optionally, the bit size of the second Precoding information and number of layers field is 1 or 3 bits according to the number of transmission layers indicated by the first Precoding information and number of layers field and the configured value of the maximum coherence capability of the antenna ports, if the maximum number of transmission layers of each PUSCH repetition is 2 and the maximum number of antenna ports of each PUSCH repetition is 2. Further, the TPMI candidates indicated by the second Precoding information and number of layers field are shown in Table 3-2.

TABLE 3-2
TPMI candidates indicated by the second Precoding information
and number of layers field in the case of antenna
ports = 4, maximum transmission layers =
2 of PUSCH when simultaneous PUSCH repetition scheme

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| . . . | . . . | 0 | 2 layers: TPMI = 0 |
| 5 | 1 layer: TPMI = 5 | 1 | 2 layers: reserved |
| 6-7 | 1 layer: reserved | | |
| 0 | 2 layers: TPMI = 0 | | |
| . . . | . . . | | |
| 2 | 2 layers: TPMI = 2 | | |
| 3-7 | 2 layers: reserved | | |

iv. In some embodiments, if the number of the PUSCH repetitions is 2, the maximum number of transmission layers of each PUSCH repetition is 1, and the maximum number of antenna ports of each PUSCH repetition is 2:
i) Optionally, the bit size of the first Precoding information and number of layers field is 1 or 3 bits according to the configured value of the maximum coherence capability of the antenna ports. Further, the TPMI candidates indicated by the first Precoding information and number of layers field are included in Table 4-1.

TABLE 4-1
TPMI candidates indicated by the first Precoding information
and number of layers field in the case of antenna
ports = 2, maximum transmission layers =
1 of PUSCH when simultaneous PUSCH repetition scheme

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

ii) Optionally, the bit size and the TPMI candidates of the second Precoding information and number of layers field is the same as the first Precoding information and number of layers field.

### Embodiment Examples 2

These embodiments may incorporate a precoder indication for CB and NCB based simultaneous PUSCH transmission occasion (e.g., no repetition PUSCH transmission in MTRP operation.

If at least one of the following conditions is satisfied,
1) The UE is scheduled to transmit more than one PUSCH transmission simultaneously, wherein the time domain of these PUSCH transmissions are fully or partially overlapped.
   a. Wherein, the PUSCH transmission can be at least one of: inter-slot based transmission or intra-slot based transmission.
   b. Wherein, the codeword of each of PUSCH transmissions is different.
2) The one or more PUSCH transmissions are configured with one or more SRS resource sets, which are configured in srs-ResourceSetToAddModList or srs-ResourceSetToAddModListDCI-0-2 with higher layer parameter usage in SRS-ResourceSet set to ‘codebook’ or ‘nonCodebook’.
3) For codebook or non-codebook based transmission scheme, the PUSCH can be scheduled by DCI format 0_1, DCI format 0_2 or RRC signaling.
4) For these PUSCH transmissions transmitted simultaneously, each of PUSCH transmissions is associated with one SRS resource set.
5) These PUSCH transmissions are indicated with different beams or spatial relations.
   the UE may gets and applies one or a plurality of precoding matrices (A.k.a precoding matrix W) to these PUSCH transmissions.
1) Wherein, the precoding matrix is used to indicate the precoder to be applied over the transmission layers.
2) Optionally, the plurality of precoding matrices are given by DCI indication or RRC signaling. Wherein, the DCI indication can be at least one of the DCI format 0_1 or DCI format 0_2, the RRC signaling can be at least one of the higher layer parameterprecodingAndNumberOfLayers or the higher layer parameter precodingAndNumberOfLayers2-r17.
   a. Here, each of precoding matrices is separately indicated by a Precoding information and number of layers field in the DCI.
      a) Wherein, the overhead of each Precoding information and number of layers field of each precoding matrix depends on at least one of the following factors:
         i. Factor-1: the maximum transmission layers of the PUSCH transmission;
         i) For an example, the maximum transmission layers are determined by the higher layer parameter maxRank in PUSCH-Config of the PUSCH repetition.
         ii. Factor-2: the maximum number of the antenna ports of the PUSCH transmission;
         i) For an example, the maximum number of the antenna ports is determined by the higher layer parameter nrofSRS-Ports in SRS-Resource of the PUSCH transmission.
         iii. Factor-3: the maximum coherence capability of the antenna ports supported by the UE of the PUSCH transmission.
         i) For an example, the maximum coherence capabilities of the antenna ports is determined by the higher layer parameter codebookSubset in PUSCH-Config of the PUSCH repetition, whose value can be configured as at least one of: ‘fullyAndPartialAndNonCoherent’, ‘partialAndNonCoherent’ or ‘nonCoherent’.
      b) Optionally, the spatial phase coefficient of the precoding matrix of the PUSCH repetition is determined and indicated to the UE.
         i. Optionally, the spatial phase coefficient is a relative value between two precoding matrices of two PUSCH transmissions.
         ii. Optionally, the spatial phase coefficient is a absolute value of the precoding matrix of the PUSCH transmission.
         iii. Optionally, the spatial phase coefficient is indicated by the Precoding information and number of layers field.
         iv. Optionally, the spatial phase coefficient is indicated by a field in DCI exclusively.
         v. Optionally, the candidate values of the spatial phase coefficient comprise at least one of: 1, j, −1 or −j.
   b. Wherein, the plurality of precoding matrices are jointly indicated by a single Precoding information and number of layers field in the DCI.
      a) Optionally, each of the precoding matrices is indicated by different bits in the Precoding information and number of layers field.
         i. For an example, if the number of PUSCH repetitions is 2, MSB bits are used to indicate the first precoding matrix of the first PUSCH transmission and LSB bits are used to indicate the second precoding matrix of the second PUSCH transmission.
      b) Optionally, a mixed precoding matrix is indicated by the Precoding information and number of layers field.
         i. Wherein, the mixed precoding matrix is combined by the plurality of precoding matrices.
         i) Wherein, if each of these PUSCH transmissions is transmitted in different transmission layers or different frequency domains and associated with different DM-RS ports, the mixed precoding matrix is derived from one of the following methods:
         a. Method-1: for an example, when the number of the PUSCH transmissions is 2, the mixed precoding matrix is derived from the following formula:

$${W}_{mixed} = [ \begin{matrix}{W}_{1} & 0 \\ 0 & {W}_{2}\end{matrix} ]$$

wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
b. Method-2: for an example, when the number of the PUSCH transmissions is 2, the mixed precoding matrix is derived from the following formula:

$${W}_{mixed} = [ \begin{matrix}{φ}_{1} {W}_{1} & 0 \\ 0 & {φ}_{2} {W}_{2}\end{matrix} ]$$

wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
φ₁ is the spatial phase coefficient of the first precoding matrix of the first PUSCH transmission.
φ₂ is the spatial phase coefficient of the second precoding matrix of the second PUSCH transmission.
c. Method-3: for an example, when the number of the PUSCH transmissions is 2, the mixed precoding matrix is derived from the following formula:

$${W}_{mixed} = [ \begin{matrix}{W}_{1} & 0 \\ 0 & Δφ {W}_{2}\end{matrix} ]$$

wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
Δφ is the relative spatial phase coefficient of the second precoding matrix of the second PUSCH transmission.
d. Method-4: for an example, when the number of the PUSCH transmissions is 2, the mixed precoding matrix is derived from the following formula:

$${W}_{mixed} = [ \begin{matrix}{W}_{11} & {W}_{12} \\ {W}_{21} & {W}_{22}\end{matrix} ]$$

wherein,
W_{mixed} is the mixed precoding matrix which combined by the plurality of precoding matrices.
W₁₁ is the first precoding matrix of the first PUSCH transmission.
W₂₂ is the second precoding matrix of the second PUSCH transmission.
W₁₂ is the precoding matrix of the interference between the transmission layers of the first and the second PUSCH transmissions.
W₂₁ is the second precoding matrix of the interference between the antenna ports of the first and the second PUSCH transmissions.
e. Method-5: for an example, when the number of the PUSCH transmissions is 2, the mixed precoding matrix is derived from the following formula:

$${W}_{mixed} = [ \begin{matrix}{φ}_{11} {W}_{11} & {W}_{12} \\ {W}_{21} & {φ}_{22} {W}_{22}\end{matrix} ]$$

wherein,
W_{mixed} is the mixed precoding matrix which combined by the plurality of precoding matrices.
W₁₁ is the first precoding matrix of the first PUSCH transmission.
W₂₂ is the second precoding matrix of the second PUSCH transmission.
W₁₂ is the precoding matrix of the interference between the transmission layers of the first and the second PUSCH transmissions.
W₂₁ is the precoding matrix of the interference between the antenna ports of the first and the second PUSCH transmissions.
φ₁ is the spatial phase coefficient of the first precoding matrix of the first PUSCH transmission.
φ₂₂ is the spatial phase coefficient of the second precoding matrix of the second PUSCH transmission.
f. Method-6: for an example, when the number of the PUSCH transmissions is 2, the mixed precoding matrix is derived from the following formula:

$${W}_{mixed} = [ \begin{matrix}{φ}_{11} {W}_{11} & {φ}_{12} {W}_{l 2} \\ {φ}_{22} {W}_{21} & {φ}_{22} {W}_{22}\end{matrix} ]$$

wherein,
W_{mixed} is the mixed precoding matrix which combined by the plurality of precoding matrices.
W₁₁ is the first precoding matrix of the first PUSCH transmission.
W₂₂ is the second precoding matrix of the second PUSCH transmission.
W₁₂ is the precoding matrix of the interference between the transmission layers of the first and the second PUSCH transmissions.
W₂₁ is the precoding matrix of the interference between the antenna ports of the first and the second PUSCH transmissions.
φ₁ is the spatial phase coefficient of the first precoding matrix of the first PUSCH transmission.
φ₂₂ is the spatial phase coefficient of the second precoding matrix of the second PUSCH transmission.
φ₁₂ is the spatial phase coefficient of the precoding matrix of the interference between the transmission layers of the first and the second PUSCH transmissions.
φ₂₁ is the spatial phase coefficient of the precoding matrix of the interference between the antenna ports of the first and the second PUSCH transmissions.
g. Method-7: for an example, when the number of the PUSCH transmissions is 2, the mixed precoding matrix is derived from the following formula:

$${W}_{mixed} = [ \begin{matrix}{W}_{11} & {Δφ}_{1} {W}_{12} \\ {Δφ}_{2} {W}_{21} & Δφ {W}_{22}\end{matrix} ]$$

wherein,
W_{mixed} is the mixed precoding matrix which combined by the plurality of precoding matrices.
W₁₁ is the first precoding matrix of the first PUSCH transmission.
W₂₂ is the second precoding matrix of the second PUSCH transmission.
W₁₂ is the precoding matrix of the interference between the transmission layers of the first and the second PUSCH transmissions.
W₂₁ is the precoding matrix of the interference between the antenna ports of the first and the second PUSCH transmissions.
Δφ is the relative spatial phase coefficient of the second precoding matrix of the second PUSCH transmissions.
Δφ₁ is the relative spatial phase coefficient of the precoding matrix of the interference between the transmission layers of the first and the second PUSCH transmissions.
Δφ₂ is the relative spatial phase coefficient of the precoding matrix of the interference between the antenna ports of the first and the second PUSCH transmissions.
h. Method-8: for an example, when the number of the PUSCH transmissions is 2, the mixed precoding matrix is derived from the following formula:

W_{mixed}=[W₁ W₂]
wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
i. Method-9: for an example, when the number of the PUSCH transmissions is 2, the mixed precoding matrix is derived from the following formula:

W_{mixed}=[φ₁W₁ φ₂W₂]
wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
φ₁ is the spatial phase coefficient of the first precoding matrix of the first PUSCH transmission.
φ₂ is the spatial phase coefficient of the second precoding matrix of the second PUSCH transmission.
j. Method-10: for an example, when the number of the PUSCH transmissions is 2, the mixed precoding matrix is derived from the following formula:

W_{mixed}=[W₁ ΔφW₂]
wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
Δφ is the relative spatial phase coefficient of the second precoding matrix of the second PUSCH transmission.
ii) Wherein, if each of these PUSCH transmissions is transmitted in same transmission layers and associated with same DM-RS port(s), the mixed precoding matrix is derived from one of the following methods:
a. Method-1: for an example, when the number of the PUSCH transmissions is 2, the mixed precoding matrix is derived from the following formula:

$${W}_{mixed} = [ \begin{matrix}{W}_{1} \\ {W}_{2}\end{matrix} ]$$

wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
b. Method-2: for an example, when the number of the PUSCH transmissions is 2, the mixed precoding matrix is derived from the following formula:

$${W}_{mixed} = [ \begin{matrix}{φ}_{1} {W}_{1} \\ {φ}_{2} {W}_{2}\end{matrix} ]$$

wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
φ₁ is the spatial phase coefficient of the first precoding matrix of the first PUSCH transmission.
φ₂ is the spatial phase coefficient of the second precoding matrix of the second PUSCH transmission.
c. Method-3: for an example, when the number of the PUSCH transmissions is 2, the mixed precoding matrix is derived from the following formula:

$${W}_{mixed} = [ \begin{matrix}{W}_{1} \\ Δφ {W}_{2}\end{matrix} ]$$

wherein,
W_{mixed} is the mixed precoding matrix which combined by the plurality of precoding matrices.
W₁ is the first precoding matrix of the first PUSCH transmission.
W₂ is the second precoding matrix of the second PUSCH transmission.
Δφ is the relative spatial phase coefficient of the second precoding matrix of the second PUSCH transmission.
c. In some embodiments, the number of the antenna ports of the precoding matrix of the PUSCH transmission satisfies at least one of the following requisites:
   a) Optionally, the number of antenna ports of each PUSCH transmission can be the same or different.
   b) Optionally, the number of antenna ports of each PUSCH transmission can be at least one of: 1, 2 or 4.
   c) Optionally, if the number of all PUSCH transmissions is two, the port combinations of the all two PUSCH transmissions comprise at least one of: {1 port, 1 port}, {1 port, 2 ports}, {2 ports, 2 ports}, {1 port, 4 ports}, {2 ports, 4 ports} or {4 ports, 4 ports}. In some embodiments, each value of the combination is associated with an SRS resource set of the PUSCH transmission. For example, the first and second values are associated with the first and second SRS resource sets, respectively.
   d) Optionally, the maximum number of antenna ports of each SRS resource of each PUSCH transmission is configured by the higher layer signaling nrofSRS-Ports in SRS-Config, where the candidate values of nrofSRS-Ports of each SRS resource of each PUSCH transmission comprise at least one of: 1 port, 2 ports or 4 ports.
d. In some embodiments, the number of transmission layers of the precoding matrix of the PUSCH transmission satisfies at least one of the following requisites:
   a) Optionally, the number of transmission layers of each PUSCH transmission is the same or different.
   b) Optionally, the maximum number of transmission layers of all PUSCH transmissions can be equal to 2, 3 or 4.
      i. Wherein, the number of transmission layers of each PUSCH transmission can be 1, 2 or 3.
   c) Optionally, if the number of all PUSCH transmissions is two, the transmission layer combinations of the all PUSCH repetition comprise at least one of: {1 layer, 1 layer}, {1 layer, 2 layers}, {1 layer, 3 layers}, {2 layers, 1 layer}, {2 layers, 2 layers}, or {3 layers, 1 layer}. In some embodiments, each value of the combination is associated with an SRS resource set, for example, the first and second values are associated with the first and second SRS resource sets, respectively.
   d) Optionally, the maximum number of transmission layers of each SRS resource set of each PUSCH transmission is configured by the higher layer signaling maxRank in pusch-Config, where the candidate values of maxRank of each SRS resources set of each PUSCH repetition comprise at least one of: 1, 2 or 3.
      i. Further, if the number of all PUSCH transmissions is two, the candidate value combinations of maxRank can be at least one of: {1, 1}, {1, 2}, {1, 3}, {2, 1}, {2, 2} or {3, 1}. In some embodiments, each value of the combination is associated with an SRS resource set, for example, the first and second values are associated with the first and second SRS resource sets, respectively.
   e) Optionally, the maximum number of transmission layers of all PUSCH transmissions which are associated with one or a plurality of SRS resource sets is jointly configured by the higher layer signaling maxRank in pusch-Config, where the candidate values of maxRank comprise at least one of: 2, 3 or 4.
e. In some embodiments, if the transmission layers of each PUSCH transmission is different, the mapping between the transmission layers and the antenna ports of each PUSCH transmission is basically determined by the indicated precoding matrix(es). Further, for non-codebook based transmission, the precoding matrix equals the identity matrix; For codebook based transmission, the precoding matrix W is given by W=1 for single-layer transmission on a single antenna port, otherwise by TPMI index obtained from the DCI which scheduling the uplink transmission or the higher layer parameters (e.g., precodingAndNumberOfLayers).
   a) Optionally, the determination of the mapping is based on at least one of the following components:
      i. Component-1: the indices of the antenna ports of each PUSCH transmission are separately ordered according to the indicated SRS resource for the PUSCH repetition. For example, PUSCH transmission 1 is associated with 2-port SRS resource 1 and PUSCH transmission 2 is associated with 4-port SRS resource 2, then the indices of the antenna ports of PUSCH transmission 1 are 0 to 1 and the the indices of the antenna ports of PUSCH transmission 2 are 0 to 3. Further, the antenna ports of PUSCH transmission 1 are {p₀,p₁} and the antenna ports of PUSCH transmission 2 are {p₀,p₁,p₂,p₃}. Besides, antenna ports starting with index=1000 are defined and used for PUSCH.
      ii. Component-2: the indices of the transmission layers of each PUSCH transmission are separately ordered according to the indicated or configured transmission layers (e.g., indicated by TPMI field, configured by the higher layer parameter precodingAndNumberOfLayers or the higher layer parameter maxRank) for the PUSCH transmission. For example, the indicated transmission layer of PUSCH transmission 1 is 1 and the indicated transmission layers of PUSCH transmission 2 are 2, then the index of the transmission layer of PUSCH transmission 1 is 0 and the indices of the transmission layers of PUSCH transmission 2 are 0 to 1. Further, the transmission layer of PUSCH transmission 1 is {v₀} and the transmission layers of PUSCH transmission 2 are {v₀,v₁}.
      iii. Component-3: the indicated precoding matrix is used for the mapping of each PUSCH transmission.
      iv. Component-4: the signals of the first PUSCH transmission on antenna ports in the set [0, . . . , v₁−1] for v₁ layers would result in signals equivalent to corresponding symbols transmitted on antenna ports [0, . . . , P₁−1] according to the indicated SRS resource of the first PUSCH transmission, and the signals of the second PUSCH transmission on antenna ports in the set [0, . . . , v₂−1] for v₂ layers would result in signals equivalent to corresponding symbols transmitted on antenna ports [0, . . . , P₂−1] according to the indicated SRS resource of the second PUSCH transmission, and so on. The following formula further explains the above mapping:

$$[ \begin{matrix}\begin{matrix}{z}_{j}^{( {p}_{0} )} ( i ) \\ ⋮\end{matrix} \\ {z}_{j}^{( {p}_{{ρ}_{j} - 1} )} ( i )\end{matrix} ] = {W}_{j} [ \begin{matrix}\begin{matrix}{y}_{j}^{( 0 )} ( i ) \\ ⋮\end{matrix} \\ {y}_{j}^{( {υ}_{j} - 1 )} ( i )\end{matrix} ]$$

wherein,
j=1, . . . , n are associated with up to n PUSCH transmissions. For example, j=1 is associated with the first PUSCH transmission, j=2 is associated with the second PUSCH transmission, and so on. Besides, n denotes the total number of PUSCH transmissions, and n>1;
[zⱼ^{(p}^{₀}⁾(i) . . . zⱼ^{P(p}^{ⱼ}⁻¹⁾⁾(i)]^{T} denotes the block of complex-valued symbols of the antenna port(s) used for the j-th PUSCH transmission. Wherein, p denotes the antenna port(s) used for the j-th PUSCH transmission, p denotes the number of the antenna port(s) used for the j-th PUSCH transmission;
[yⱼ⁽⁰⁾(i) . . . yⱼ^{(v}^{ⱼ}⁻¹⁾(i)]^{T} denotes the block of complex-valued symbols of the transmission layer(s) used for the j-th PUSCH transmission. Wherein, v denotes the number of transmission layer(s) used for the j-th PUSCH transmission;
Wⱼ denotes the indicated precoding matrix used for the j-th PUSCH transmission;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
b) Optionally, the determination of the mapping is based on at least one of the following components:
   i. Component-1: the indices of the antenna ports of each PUSCH transmission are separately ordered according to the indicated SRS resource for the PUSCH transmission. For example, PUSCH transmission 1 is associated with 2-port SRS resource 1 and PUSCH transmission 2 is associated with 4-port SRS resource 2, then the indices of the antenna ports of PUSCH transmission 1 are 0 to 1 and the the indices of the antenna ports of PUSCH transmission 2 are 0 to 3. Further, the antenna ports of PUSCH transmission 1 are {p₀,p₁} and the antenna ports of PUSCH transmission 2 are {p₀,p₁,p₂,p₃}. Besides, antenna ports starting with index=1000 are defined and used for PUSCH.
   ii. Component-2: the indices of the transmission layers of all PUSCH transmissions are jointly ordered according to the indicated or configured transmission layers (e.g., indicated by TPMI field, configured by the higher layer parameter precodingAndNumberOfLayers or the higher layer parameter maxRank) for these PUSCH transmissions. For example, the indicated transmission layer of PUSCH transmission 1 is 1 and the indicated transmission layers of PUSCH transmission 2 are 2, then the index of the transmission layer of PUSCH transmission 1 is 0 and the indices of the transmission layers of PUSCH transmission 2 are 1 to 2. Further, the transmission layer of PUSCH transmission 1 is {v₀} and the transmission layers of PUSCH transmission 2 are {v₁,v₂}.
   iii. Component-3: the indicated precoding matrix is used for the mapping of each PUSCH transmission.
   iv. Component-4: the signals of the first PUSCH transmission on antenna ports in the set [0, . . . , v₁−1] for v₁ layers would result in signals equivalent to corresponding symbols transmitted on antenna ports [0, . . . , P₁−1] according to the indicated SRS resource of the first PUSCH transmission, and the signals of the second PUSCH transmission on antenna ports in the set [v₁, . . . , v₁+v₂−1] for v₂ layers would result in signals equivalent to corresponding symbols transmitted on antenna ports [0, . . . , P₂−1] according to the indicated SRS resource of the second PUSCH transmission, and so on. The following formula further explains the above mapping:

$$[ \begin{matrix}\begin{matrix}{z}_{j}^{( {p}_{0} )} ( i ) \\ ⋮\end{matrix} \\ {z}_{j}^{( {p}_{{ρ}_{j} - 1} )} ( i )\end{matrix} ] = {W}_{j} [ \begin{matrix}\begin{matrix}{y}^{( {\sum }_{j = 1}^{n - 1} {v}_{j} )} ( i ) \\ ⋮\end{matrix} \\ {y}^{( ( {\sum }_{j = 1}^{N} {v}_{j} ) - 1 )} ( i )\end{matrix} ] , n > 1 ;$$

wherein,
n denotes the total number of PUSCH repetitions, and n>1;
j=1, . . . , n are associated with up to n PUSCH transmissions. For example, j=1 is associated with the first PUSCH transmission, j=2 is associated with the second PUSCH transmission, and so on;
[zⱼ^{(p}^{₀}⁾(i) . . . zⱼ^{(p(p}^{ⱼ}⁻¹⁾⁾(i)]^{T} denotes the block of complex-valued symbols of the antenna port(s) used for the j-th PUSCH transmission. Wherein, p denotes the antenna port(s) used for the j-th PUSCH transmission, p denotes the number of the antenna port(s) used for the j-th PUSCH transmission;

$${[ {y}^{( {\sum }_{j = 1}^{n - 1} {v}_{j} )} ( i ) … {y}^{( ( {\sum }_{j = 1}^{n} {v}_{j} ) - 1 )} ( i ) ]}^{T}$$

denotes the block of complex-valued symbols of the transmission layer(s) used for the j-th PUSCH transmission. Wherein, v denotes the number of transmission layer(s) used for the j-th PUSCH transmission;
Wⱼ denotes the indicated precoding matrix used for the j-th PUSCH transmission;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
c) Optionally, the determination of the mapping is based on at least one of the following components:
   i) Component-1: the indices of the antenna ports of each PUSCH transmission are jointly ordered according to the indicated SRS resources for these PUSCH transmissions. For example, PUSCH transmission 1 is associated with 2-port SRS resource 1 and PUSCH transmission 2 is associated with 4-port SRS resource 2, then the indices of the antenna ports of PUSCH transmission 1 are 0 to 1 and the the indices of the antenna ports of PUSCH transmission 2 are 2 to 5. Further, the antenna ports of PUSCH transmission 1 are {p₀,p₁} and the antenna ports of PUSCH transmission 2 are {p₂,p₃,p₄,p₅}. Besides, antenna ports starting with index=1000 are defined and used for PUSCH.
   ii) Component-2: the indices of the transmission layers of each PUSCH transmission are separately ordered according to the indicated or configured transmission layers (e.g., indicated by TPMI field, configured by the higher layer parameter precodingAndNumberOfLayers or the higher layer parameter maxRank) for the PUSCH transmission. For example, the indicated transmission layer of PUSCH transmission 1 is 1 and the indicated transmission layers of PUSCH transmission 2 are 2, then the index of the transmission layer of PUSCH transmission 1 is 0 and the indices of the transmission layers of PUSCH transmission 2 are 0 to 1. Further, the transmission layer of PUSCH transmission 1 is {v₀} and the transmission layers of PUSCH transmission 2 are {v₀,v₁}.
   iii) Component-3: the indicated precoding matrix is used for the mapping of each PUSCH transmission.
   iv) Component-4: the signals of the first PUSCH transmission on antenna ports in the set [0, . . . , v₁−1] for v₁ layers would result in signals equivalent to corresponding symbols transmitted on antenna ports [₀, . . . , P₁−1] according to the indicated SRS resource of the first PUSCH transmission, and the signals of the second PUSCH transmission on antenna ports in the set [0, . . . , v₂−1] for v₂ layers would result in signals equivalent to corresponding symbols transmitted on antenna ports [P₀, . . . , P₁+P₂−1] according to the indicated SRS resource of the second PUSCH transmission, and so on. The following formula further explains the above mapping:

$$[ \begin{matrix}{z}^{( {p}_{( {\sum }_{j = 1}^{n - 1} {ρ}_{j} )} )} ( i ) \\ \begin{matrix}⋮ \\ {z}^{( {p}_{( {( {\sum }_{j = 1}^{n} {ρ}_{j} )}^{- 1} )} )} ( i )\end{matrix}\end{matrix} ] = {W}_{j} [ \begin{matrix}\begin{matrix}{y}_{j}^{( 0 )} ( i ) \\ ⋮\end{matrix} \\ {y}_{j}^{( {v}_{j} - 1 )} ( i )\end{matrix} ] , n > 1 ;$$

wherein,
n denotes the total number of PUSCH repetitions, and n>1;
j=1, . . . , n are associated with up to n PUSCH transmissions. For example, j=1 is associated with the first PUSCH transmission, j=2 is associated with the second PUSCH transmission, and so on;
[z^{(p}^{₀}⁾(i) . . . z^{(p(p}^{ⱼ}⁻¹⁾⁾(i)]^{T} denotes the block of complex-valued symbols of the antenna port(s) used for the j-th PUSCH transmission. Wherein, p denotes the antenna port(s) used for the j-th PUSCH transmission, p denotes the number of the antenna port(s) used for the j-th PUSCH transmission;

$${[ {y}_{j}^{( {\sum }_{j = 1}^{n - 1} {v}_{j} )} ( i ) … {y}_{j}^{( ( {\sum }_{j = 1}^{n} {v}_{j} ) - 1 )} ( i ) ]}^{T}$$

denotes the block of complex-valued symbols of the transmission layer(s) used for the j-th PUSCH transmission. Wherein, v denotes the number of transmission layer(s) used for the j-th PUSCH transmission;
Wⱼ denotes the indicated precoding matrix used for the j-th PUSCH transmission;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
d) Optionally, the determination of the mapping is based on at least one of the following components:
   i. Component-1: the indices of the antenna ports of each PUSCH transmission are jointly ordered according to the indicated SRS resources for these PUSCH transmissions. For example, PUSCH transmission 1 is associated with 2-port SRS resource 1 and PUSCH transmission 2 is associated with 4-port SRS resource 2, then the indices of the antenna ports of PUSCH transmission 1 are 0 to 1 and the the indices of the antenna ports of PUSCH transmission 2 are 2 to 5. Further, the antenna ports of PUSCH transmission 1 are {p₀,p₁} and the antenna ports of PUSCH transmission 2 are {p₂,p₃,p₄,p₅}. Besides, antenna ports starting with index=1000 are defined and used for PUSCH.
   ii. Component-2: the indices of the transmission layers of all PUSCH transmissions are jointly ordered according to the indicated or configured transmission layers (e.g., indicated by TPMI field, configured by the higher layer parameter precodingAndNumberOfLayers or the higher layer parameter maxRank) for these PUSCH transmissions. For example, the indicated transmission layer of PUSCH transmission 1 is 1 and the indicated transmission layers of PUSCH transmission 2 are 2, then the index of the transmission layer of PUSCH transmission 1 is 0 and the indices of the transmission layers of PUSCH transmission 2 are 1 to 2. Further, the transmission layer of PUSCH transmission 1 is {v₁} and the transmission layers of PUSCH transmission 2 are {v₁,v₂}.
   iii. Component-3: the indicated precoding matrix is used for the mapping of each PUSCH transmission.
   iv. Component-4: the signals of the first PUSCH transmission on antenna ports in the set [0, . . . , v₁−1] for v₁ layers would result in signals equivalent to corresponding symbols transmitted on antenna ports [0, . . . , P₁−1] according to the indicated SRS resource of the first PUSCH transmission, and the signals of the second PUSCH transmission on antenna ports in the set [v₁, . . . , v₁+v₂−1] for v₂ layers would result in signals equivalent to corresponding symbols transmitted on antenna ports [P₁, . . . , P₁+P₂−1] according to the indicated SRS resource of the second PUSCH transmission, and so on. The following formula further explains the above mapping:

$$[ \begin{matrix}\begin{matrix}{z}^{( {p}_{( {\sum }_{j = 1}^{n - 1} {ρ}_{j} )} )} ( i ) \\ ⋮\end{matrix} \\ {z}^{( {p}_{( ( {\sum }_{j = 1}^{n} {ρ}_{j} ) - 1 )} )} ( i )\end{matrix} ] = {W}_{j} [ \begin{matrix}\begin{matrix}{y}^{( {\sum }_{j = 1}^{n - 1} {v}_{j} )} ( i ) \\ ⋮\end{matrix} \\ {y}^{( ( {\sum }_{j = 1}^{n} {v}_{j} ) - 1 )} ( i )\end{matrix} ] , n > 1 ;$$

wherein,
n denotes the total number of PUSCH transmissions, and n>1;
j=1, . . . , n are associated with up to n PUSCH transmissions. For example, j=1 is associated with the first PUSCH transmission, j=2 is associated with the second PUSCH transmission, and so on;

$${[ {z}^{( {p}_{( {\sum }_{j = 1}^{n - 1} {ρ}_{j} )} )} ( i ) … {z}^{( {p}_{( {( {\sum }_{j = 1}^{n} {ρ}_{j} )}^{- 1} )} )} ( i ) ]}^{T}$$

denotes the block of complex-valued symbols of the antenna port(s) used for the j-th PUSCH transmission. Wherein, p denotes the antenna port(s) used for the j-th PUSCH transmission, ρ denotes the number of the antenna port(s) used for the j-th PUSCH transmission;

$${[ {y}^{( {\sum }_{j = 1}^{n - 1} {v}_{j} )} ( i ) … {y}^{( ( {\sum }_{j = 1}^{n} {v}_{j} ) - 1 )} ( i ) ]}^{T}$$

denotes the block of complex-valued symbols of the transmission layer(s) used for the j-th PUSCH transmission. Wherein, v denotes the number of transmission layer(s) used for the j-th PUSCH transmission;
Wⱼ denotes the indicated precoding matrix used for the j-th PUSCH transmission;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
e) Optionally, the determination of the mapping is based on at least one of the following components:
   i. Component-1: the indices of the antenna ports of each PUSCH transmission are jointly ordered according to the indicated SRS resources for these PUSCH transmissions. For example, PUSCH transmission 1 is associated with 2-port SRS resource 1 and PUSCH transmission 2 is associated with 4-port SRS resource 2, then the indices of the antenna ports of PUSCH transmission 1 are 0 to 1 and the the indices of the antenna ports of PUSCH transmission 2 are 2 to 5. Further, the antenna ports of PUSCH transmission 1 are {p₀,p₁} and the antenna ports of PUSCH transmission 2 are {p₂,p₃,p₄,p₅}. Besides, antenna ports starting with index=1000 are defined and used for PUSCH.
   ii. Component-2: the indices of the transmission layers of all PUSCH transmissions are jointly ordered according to the indicated or configured transmission layers (e.g., indicated by TPMI field, configured by the higher layer parameter precodingAndNumberOfLayers or the higher layer parameter maxRank) for these PUSCH transmissions. For example, the indicated transmission layer of PUSCH transmission 1 is 1 and the indicated transmission layers of PUSCH transmission 2 are 2, then the index of the transmission layer of PUSCH transmission 1 is 0 and the indices of the transmission layers of PUSCH transmission 2 are 1 to 2. Further, the transmission layer of PUSCH transmission 1 is {v₀} and the transmission layers of PUSCH transmission 2 are {v₁,v₂}.
   iii. Component-3: the indicated precoding matrix is used for the mapping of each PUSCH transmission.
   iv. Component-4: the signals of the first PUSCH transmission on antenna ports in the set [0, . . . , v₁−1] for v₁ layers would result in signals equivalent to corresponding symbols transmitted on antenna ports [0, . . . , P₁−1] according to the indicated SRS resource of the first PUSCH transmission, and the signals of the second PUSCH transmission on antenna ports in the set [v₁, . . . , v₁+v₂−1] for v₂ layers would result in signals equivalent to corresponding symbols transmitted on antenna ports [P₁, . . . , P₁+P₂−1] according to the indicated SRS resource of the second PUSCH transmission, and so on. The following formula further explains the above mapping:

$$[ \begin{matrix}\begin{matrix}[ \begin{matrix}{z}^{( {p}_{0} )} ( i ) \\ ⋮ \\ {z}^{( {p}_{0} )} ( i )\end{matrix} ] \\ ⋮\end{matrix} \\ [ \begin{matrix}{z}^{( {p}_{( {\sum }_{j = 1}^{n - 1} {ρ}_{j} )} )} ( i ) \\ ⋮ \\ {z}^{( {p}_{( ( {\sum }_{j = 1}^{n - 1} {ρ}_{j} ) - 1 )} )} ( i )\end{matrix} ]\end{matrix} ] = [ \begin{matrix}{W}_{1} & & \\ & ⋱ & \\ & & {W}_{j}\end{matrix} ] \times [ \begin{matrix}\begin{matrix}[ \begin{matrix}{y}^{( 0 )} ( i ) \\ ⋮ \\ {y}^{( v - 1 )} ( i )\end{matrix} ] \\ ⋮\end{matrix} \\ [ \begin{matrix}{y}^{( {\sum }_{j = 1}^{n - 1} {v}_{j} )} ( i ) \\ ⋮ \\ {y}^{( ( {\sum }_{j = 1}^{n - 1} {ρ}_{j} ) - 1 )} ( i )\end{matrix} ]\end{matrix} ] , n > 1 ;$$

wherein,
n denotes the total number of PUSCH transmissions, and n>1;
j=1, . . . , n are associated with up to n PUSCH transmissions. For example, j=1 is associated with the first PUSCH transmission, j=2 is associated with the second PUSCH transmission, and so on;

$${[ {z}^{( {p}_{( {\sum }_{j = 1}^{n - 1} {ρ}_{j} )} )} ( i ) … {z}^{( {p}_{( {( {\sum }_{j = 1}^{n - 1} {ρ}_{j} )}^{- 1} )} )} ( i ) ]}^{T}$$

denotes the block of complex-valued symbols of the antenna port(s) used for the j-th PUSCH repetition. Wherein, p denotes the antenna port(s) used for the j-th PUSCH transmission, p denotes the number of the antenna port(s) used for the j-th PUSCH transmission;

$${[ {y}^{( {\sum }_{j = 1}^{n - 1} {v}_{j} )} ( i ) … {y}^{( ( {\sum }_{j = 1}^{n} {v}_{j} ) - 1 )} ( i ) ]}^{T}$$

denotes the block of complex-valued symbols of the transmission layer(s) used for the j-th PUSCH transmission. Wherein, v denotes the number of transmission layer(s) used for the j-th PUSCH transmission;
Wⱼ denotes the indicated precoding matrix used for the j-th PUSCH transmission;
i=0, 1, . . . , M_{symb}^{ap}−1, M_{symb}^{ap}=M_{symb}^{layer}, where M_{symb}^{layer} is the number of modulation symbols per layer and M_{symb}^{ap} is the number of antenna ports per layer.
f. In some embodiments, the power ratio of the precoding matrix of the PUSCH transmission satisfies at least one of the following requisites:
   a) Further, the higher layer parameter txConfig in PUSCH-Config of each PUSCH transmission is set to ‘codebook’;
   b) Further, the UE first calculates a linear value of the total transmit power of all these PUSCH transmissions which would be transmitted simultaneously, and the UE scales the linear value by the power ratio;
   c) Optionally, the power ratio of one PUSCH transmission is determined or calculated by the following formula:

$$s = \frac{1}{{N}_{rep}} \times \frac{{N}_{{p}_{nz}}}{{N}_{{P}_{max}}}$$

Wherein,
s denotes the power ratio;
Nᵣₑₚ denotes the total number of PUSCH transmissions which would be transmitted simultaneously; Optionally, Nᵣₑₚ is equivalent to the total number of SRS resources sets which associated with all these PUSCH transmissions;
N_{P}_{_{nz}} denotes the number of antenna ports with non-zero transmission power of the PUSCH transmission and which may be indicated by the precoding matrix of the PUSCH transmission;
N_{P}_{ₘₐₓ} denotes the maximum number of SRS ports supported by the UE in one SRS resource within one SRS resource set, wherein the SRS resource set is associated with the PUSCH transmission.
d) Optionally, the power ratio of one PUSCH transmission is determined or calculated by the following formula:

$$s = \frac{{N}_{{P}_{max}}}{{\sum }_{i = 1}^{n} {N}_{{P}_{max , i}}} \times \frac{{N}_{{P}_{nz}}}{{N}_{{P}_{max}}}$$

Wherein,
s denotes the power ratio;
N_{P}_{ₘₐₓ} denotes the maximum number of SRS ports supported by the UE in one SRS resource within one SRS resource set, wherein the SRS resource set is associated with the PUSCH transmission.
N_{P}_{_{max,i}} denotes the maximum number of SRS ports supported by the UE in one SRS resource within one SRS resource set, wherein the SRS resource set is associated with the i-th PUSCH transmission.
n denotes the total number of all these PUSCH transmissions which would be transmitted simultaneously;
i=1, . . . , n and is associated with up to n PUSCH transmissions one by one. For example, i=1 is associated with the first PUSCH transmission, i=2 is associated with the second PUSCH transmission, and so on;
N_{P}_{_{nz}} denotes the number of antenna ports with non-zero transmission power of the PUSCH transmission and which may be indicated by the precoding matrix of the PUSCH transmission.
e) Optionally, the power ratio of one PUSCH repetitions is determined or calculated by the following formula:

$$s = \frac{{N}_{{p}_{nz}}}{{{\sum }_{i = 1}}^{n} {N}_{{p}_{nz , i}}}$$

Wherein,
s denotes the power ratio;
N_{P}_{_{nz}} denotes the number of antenna ports with non-zero transmission power of the PUSCH transmission and which may be indicated by the precoding matrix of the PUSCH transmission;
N_{P}_{_{nz,i}} denotes the number of antenna ports with non-zero transmission power of the i-th PUSCH transmission and which may be indicated by the precoding matrix of the i-th PUSCH transmission;
n denotes the total number of all these PUSCH transmissions which would be transmitted simultaneously;
i=1, . . . , n and is associated with up to n PUSCH transmissions one by one. For example, i=1 is associated with the first PUSCH transmission, i=2 is associated with the second PUSCH transmission, and so on;
g. In some embodiments, if these PUSCH transmissions are scheduled by DCI format 0_1 or DCI format 0_2, the UE determines the precoder(s) of each PUSCH transmission upon TPMI(s) which indicated by Precoding information and number of layers field(s) in DCI if the number of antenna ports of the PUSCH repetition is more than 1.
   a) Further, the candidates of TPMI which indicated by the Precoding information and number of layers field are dedicated to different cases:
      i. Optionally, if the number of the PUSCH transmissions is 2, the bit size of the Precoding information and number of layers field is 4, 5, or 6 bits according to the configured value of the maximum coherence capability of the antenna ports, if the maximum number of transmission layers of the PUSCH transmission is 2, 3 or 4 and the maximum number of antenna ports of the PUSCH transmission is 4. Further, the candidates of the indicated TPMI comprise the values as in the following Table 1.

TABLE 1
TPMI candidates for the case of antenna ports = 4, maximum transmission
layers = 2, 3 or 4 when simultaneous PUSCH transmission

| Bit | | Bit | | Bit | |
|---|---|---|---|---|---|
| field | | field | | field | |
| mapped | | mapped | | mapped | |
| to | codebookSubset = | to | codebookSubset = | to | codebookSubset = |
| index | fullyAndPartialAndNonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 2 layers: TPMI = 0 | 4 | 2 layers: TPMI = 0 | 4 | 2 layers: TPMI = 0 |
| . . . | . . . | . . . | . . . | . . . | . . . |
| 9 | 2 layers: TPMI = 5 | 9 | 2 layers: TPMI = 5 | 9 | 2 layers: TPMI = 5 |
| 10 | 3 layers: TPMI = 0 | 10 | 3 layers: TPMI = 0 | 10 | 3 layers: TPMI = 0 |
| . . . | . . . | . . . | . . . | 11-15 | reserved |
| 18 | 1 layer: TPMI = 11 | 18 | 1 layer: TPMI = 11 | | |
| 19 | 2 layers: TPMI = 6 | 19 | 2 layers: TPMI = 6 | | |
| . . . | . . . | . . . | . . . | | |
| 26 | 2 layers: TPMI = 13 | 26 | 2 layers: TPMI = 13 | | |
| 27 | 3 layers: TPMI = 1 | 27 | 3 layers: TPMI = 1 | | |
| 28 | 3 layers: TPMI = 2 | 28 | 3 layers: TPMI = 2 | | |
| 29 | 1 layers: TPMI = 12 | 29-31 | reserved | | |
| . . . | . . . | | | | |
| 45 | 1 layers: TPMI = 27 | | | | |
| 46 | 2 layers: TPMI = 14 | | | | |
| . . . | . . . | | | | |
| 52 | 2 layers: TPMI = 21 | | | | |
| 54 | 3 layers: TPMI = 3 | | | | |
| . . . | . . . | | | | |
| 56 | 3 layers: TPMI = 6 | | | | |
| 57-63 | reserved | | | | |

ii. Optionally, if the number of the PUSCH transmissions is 2, the bit size of the Precoding information and number of layers field is 2, 4, or 5 bits according to the configured value of the maximum coherence capability of the antenna ports, if the maximum number of transmission layers of the PUSCH transmission is 1 and the maximum number of antenna ports of the PUSCH transmission is 4. Further, the candidates of the indicated TPMI comprise the values as in the following Table 2.

TABLE 2
TPMI candidates for the case of antenna ports = 4, maximum transmission
layer = 1 when simultaneous PUSCH transmission

| Bit | | Bit | | Bit | |
|---|---|---|---|---|---|
| field | | field | | field | |
| mapped | | mapped | | mapped | |
| to | codebookSubset = | to | codebookSubset = | to | codebookSubset = |
| index | fullyAndPartialAndNonCoherent | index | partialAndNonCoherent | index | nonCoherent |
| 0 | 1 layer: TPMI = 0 | 0 | 1 layer: TPMI = 0 | 0 | 1 layer: TPMI = 0 |
| 1 | 1 layer: TPMI = 1 | 1 | 1 layer: TPMI = 1 | 1 | 1 layer: TPMI = 1 |
| . . . | . . . | . . . | . . . | . . . | . . . |
| 3 | 1 layer: TPMI = 3 | 3 | 1 layer: TPMI = 3 | 3 | 1 layer: TPMI = 3 |
| 4 | 1 layer: TPMI = 4 | 4 | 1 layer: TPMI = 4 | | |
| . . . | . . . | . . . | . . . | | |
| 11 | 1 layer: TPMI = 11 | 11 | 1 layer: TPMI = 11 | | |
| 12 | 1 layers: TPMI = 12 | 12-15 | reserved | | |
| . . . | . . . | | | | |
| 27 | 1 layers: TPMI = 27 | | | | |
| 28-31 | reserved | | | | |

iii. Optionally, if the number of the PUSCH transmissions is 2, the bit size of the Precoding information and number of layers field is 2 or 4 bits according to the configured value of the maximum coherence capability of the antenna ports, if the maximum number of transmission layers of the PUSCH transmission is 2 and the maximum number of antenna ports of the PUSCH transmission is 2. Further, the candidates of the indicated TPMI comprise the values as in the following Table 3.

TABLE 3
TPMI candidates for the case of antenna
ports = 2, maximum transmission
layer = 2 when simultaneous PUSCH transmission

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 2 layers: TPMI = 0 | 2 | 2 layers: TPMI = 0 |
| 3 | 1 layer: TPMI = 2 | 3 | reserved |
| 4 | 1 layer: TPMI = 3 | | |
| 5 | 1 layer: TPMI = 4 | | |
| 6 | 1 layer: TPMI = 5 | | |
| 7 | 2 layers: TPMI = 1 | | |
| 8 | 2 layers: TPMI = 2 | | |
| 9-15 | reserved | | |

iv. Optionally, if the number of the PUSCH transmissions is 2, the bit size of the Precoding information and number of layers field is 1 or 3 bits according to the configured value of the maximum coherence capability of the antenna ports, if the maximum number of transmission layers of the PUSCH transmission is 1 and the maximum number of antenna ports of the PUSCH transmission is 2. Further, the candidates of the indicated TPMI comprise the values as in the following Table 4.

TABLE 4
TPMI candidates for the case of antenna
ports = 2, maximum transmission
layer = 1 when simultaneous PUSCH transmission

| Bit field | | Bit field | |
|---|---|---|---|
| mapped | codebookSubset = | mapped | codebookSubset = |
| to index | fullyAndPartialAndNonCoherent | to index | nonCoherent |
| 0 | 1 layer: TPMI = 0 | 0 | 1 layer: TPMI = 0 |
| 1 | 1 layer: TPMI = 1 | 1 | 1 layer: TPMI = 1 |
| 2 | 1 layer: TPMI = 2 | | |
| 3 | 1 layer: TPMI = 3 | | |
| 4 | 1 layer: TPMI = 4 | | |
| 5 | 1 layer: TPMI = 5 | | |
| 6-7 | reserved | | |

### Embodiment Examples 3

These embodiments may incorporate an SRI indication for NCB based simultaneous PUSCH repetition in MTRP operation.

If at least one of the following conditions is satisfied,
1) The UE is scheduled to transmit more than one PUSCH repetition simultaneously, wherein the time domain of these PUSCH repetitions are fully or partially overlapped.
   a. In some embodiments, the PUSCH repetition can be at least one of: inter-slot based PUSCH repetition or intra-slot based PUSCH repetition.
   b. In some embodiments, these PUSCH repetitions are transmitted with same or different RV.
2) The one or more PUSCH repetitions are configured with one or more SRS resource sets, which are configured in srs-ResourceSetToAddModList or srs-ResourceSetToAddModListDCI-0-2 with higher layer parameter usage in SRS-ResourceSet set to ‘nonCodebook’. 3) For non-codebook based transmission scheme, the PUSCH can be scheduled by DCI format 0_1, DCI format 0_2 or RRC signaling.
4) For these PUSCH repetitions transmitted simultaneously, each of PUSCH repetitions is associated with one SRS resource set.
5) These PUSCH repetitions are indicated with different beams or spatial relations.
   the UE may gets and applies one or a plurality of SRIs to these PUSCH repetitions.
1) Optionally, the plurality of SRIs are given by DCI indication or RRC signaling. In some embodiments, the DCI indication can be at least one of the DCI format 0_1 or DCI format 0_2, the RRC signaling can be at least one of the higher layer parameter srs-ResourceIndicator or the higher layer parameter srs-ResourceIndicator2-r17.
   a. In some embodiments, each of SRIs is separately indicated by a SRS resource indicator field in the DCI.
      a) In some embodiments, the overhead of each SRS resource indicator field of each SRI depends on at least one of the following factors:
         i. Factor-1: the maximum transmission layers of the PUSCH repetition;
         i) For an example, the maximum transmission layers is configured by the higher layer parameter maxMIMO-Layers in PUSCH-ServingCellConfig of the PUSCH repetition, or is given by the maximum number of layers for PUSCH supported by the UE for the serving cell of the PUSCH repetition.
         ii) Optionally, the number of transmission layers of each PUSCH repetition is the same.
         iii) Optionally, the maximum number of transmission layers of all PUSCH repetitions should be equal to 2 or 4.
         a. In some embodiments, the number of transmission layers of each PUSCH repetition can be 1 or 2.
         iv) Optionally, if the number of all PUSCH repetitions is two, the transmission layer combinations of the all PUSCH repetition comprise at least one of: {1 layer, 1 layer} or {2 layers, 2 layers}. In some embodiments, each value of the combination is associated with an SRS resource set, for example, the first and second values are associated with the first and second SRS resource sets, respectively.
         v) Optionally, the maximum number of transmission layers of each SRS resource set of each PUSCH repetition is separately configured by the higher layer signaling maxMIMO-Layers in PUSCH-ServingCellConfig of the PUSCH repetition or is given by the maximum number of layers for PUSCH supported by the UE for the serving cell of the PUSCH repetition, where the candidate values of maxMIMO-Layers or reported by the UE of each SRS resources set of each PUSCH repetition comprise at least one of: 1 or 2.
         a. Further, the maximum number of transmission layers of each SRS resource set of each PUSCH repetition is equal to the configured value of maxMIMO-Layers in PUSCH-ServingCellConfig or reported by the UE of each SRS resources set of each PUSCH repetition divided by the number of SRS resource sets which associated with all PUSCH repetitions. For example, if the configured value is 2 and the total number of SRS resource sets is 2, the maximum number of transmission layers of each PUSCH repetition is equal to 1. If the configured value is 4 and the total number of SRS resource sets is 2, the maximum number of transmission layers of each PUSCH repetition is equal to 2.
         ii. Factor-2: the number of configured SRS resources in a SRS resource set associated with the PUSCH repetition.
         i) For an example, the number of configured SRS resources in a SRS resource set is configured by the higher layer parameter srs-ResourceIdList in SRS-ResourceSet of the PUSCH repetition.
         ii) Optionally, the number of configured SRS resources in a SRS resource set of each PUSCH repetition can be the same or different.
         iii) Optionally, the maximum number of configured SRS resources in a SRS resource set of each PUSCH repetition is separately configured, where the candidate values comprise at least one of: 1, 2, 3 or 4.
         iv) Optionally, if the number of all PUSCH repetitions is two, the combinations of the configured SRS resources of the all two PUSCH repetitions comprise at least one of: {1, 1}, {1, 2}, {1, 3}, {1, 4}, {2, 1}, {2, 2}, {2, 3}, {2, 4}, {3, 1}, {3, 2}, {3, 3}, {3, 4}, {4, 1}, {4, 2}, {4, 3} or {4, 4}. In some embodiments, each value of the combination is associated with an SRS resource set of the PUSCH repetition. For example, the first and second values are associated with the first and second SRS resource sets, respectively.
   b. In some embodiments, the plurality of SRIs are jointly indicated by a single SRS resource indicator field in the DCI.
      a) Optionally, a mixed SRI is indicated by the single SRS resource indicator field and is combined by a plurality of SRIs, In some embodiments each of SRIs is indicated by different bits in the SRS resource indicator field.
         i. For an example, if the number of PUSCH repetitions is 2, MSB bits are used to indicate the first SRI of the first PUSCH repetition and LSB bits are used to indicate the second SRI of the second PUSCH repetition.
      b) Optionally, a mixed SRI is indicated by the SRS resource indicator field and the value of the mixed SRI comprises the combination of the SRS resources for each PUSCH repetition.
   c. Further, the spatial phase coefficient of the PUSCH repetition is determined and indicated to the UE.
      a) Optionally, the spatial phase coefficient is a relative value between two PUSCH repetitions.
      b) Optionally, the spatial phase coefficient is a absolute value of the PUSCH repetition.
      c) Optionally, the spatial phase coefficient is indicated by the SRS resource indicator field.
      d) Optionally, the spatial phase coefficient is indicated by a field in DCI exclusively.
      e) Optionally, the candidate values of the spatial phase coefficient comprise at least one of: 1, j, −1 or −j.
   d. In some embodiments, if these PUSCH repetitions are scheduled by DCI format 0_1 or DCI format 0_2, the UE determines the SRI of each PUSCH repetition which indicated by SRS resource indicator field(s) in DCI if the number of the associated SRS resources of the PUSCH repetition is more than 1.
      a) Further, the candidates of SRI which indicated by the SRS resource indicator field are dedicated to different cases:
         i. In some embodiments, if the number of the PUSCH repetitions is 2 and the maximum number of transmission layers (denoted as Lₘₐₓ) of each PUSCH repetition is 1:
         i) Optionally, the bit size of the first SRS resource indicator field is 1, 2 or 2 bits according to the configured value of the maximum SRS resources (denoted as N_{SRS}) of the PUSCH repetition. Further, the SRI candidates indicated by the first SRS resource indicator field are included in Table 1-1.

TABLE 1-1
SRI candidates indicated by the first SRS resource indicator
field in the case of maximum transmission layers Lₘₐₓ =
1 of PUSCH when simultaneous PUSCH repetition scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| | | 2 | 2 | 2 | 2 |
| | | 3 | reserved | 3 | 3 |

ii) Optionally, the bit size and the SRI candidates of the second SRS resource indicator field is the same as the first SRS resource indicator field.
b) Further, the candidates of SRI which indicated by the SRS resource indicator field are dedicated to different cases:
   i. In some embodiments, if the number of the PUSCH repetitions is 2 and the maximum number of transmission layers (denoted as Lₘₐₓ) of each PUSCH repetition is 2:
   i) Optionally, the bit size of the first SRS resource indicator field is 2, 3 or 4 bits according to the configured value of the maximum SRS resources (denoted as N_{SRS}) of the PUSCH repetition. Further, the SRI candidates indicated by the first SRS resource indicator field are included in Table 2-1.

TABLE 2-1
SRI candidates indicated by the first SRS resource indicator
field in the case of maximum transmission layers Lₘₐₓ =
2 of PUSCH when simultaneous PUSCH repetition scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

ii) Optionally, the bit size of the second SRS resource indicator field is 2, 3 or 4 bits according to the number of transmission layers indicated by the second SRS resource indicator field field and the configured value of the maximum SRS resources (denoted as N_{SRS}) of the PUSCH repetition. Further, the SRI candidates indicated by the first SRS resource indicator field are included in Table 2-2.

TABLE 2-2
SRI candidates indicated by the second SRS resource indicator
field in the case of maximum transmission layers Lₘₐₓ =
2 of PUSCH when simultaneous PUSCH repetition scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 0 | 0, 1 | 2 | 2 | 2 | 2 |
| 1 | 2 layers: | 3 | 1 layer: | 3 | 3 |
| | reserved | | reserved | | |
| | | 0 | 0, 1 | 4-7 | 1 layer: |
| | | | | | reserved |
| | | 1 | 0, 2 | 0 | 0, 1 |
| | | 2 | 1, 2 | 1 | 0, 2 |
| | | 3 | 2 layers: | 2 | 0, 3 |
| | | | reserved | | |
| | | | | 3 | 1, 2 |
| | | | | 4 | 1, 3 |
| | | | | 5 | 2, 3 |
| | | | | 6-7 | 2 layers: |
| | | | | | reserved |

c) Further, the candidates of SRI which indicated by the SRS resource indicator field are dedicated to different cases:
   i. In some embodiments, if the number of the PUSCH repetitions is 2 and the maximum number of transmission layers (denoted as Lₘₐₓ) of each PUSCH repetition is 3:
   i) Optionally, the bit size of the first SRS resource indicator field is 2, 3 or 4 bits according to the configured value of the maximum SRS resources (denoted as N_{SRS}) of the PUSCH repetition. Further, the SRI candidates indicated by the first SRS resource indicator field are included in Table 3-1.

TABLE 3-1
SRI candidates indicated by the first SRS resource indicator
field in the case of maximum transmission layers Lₘₐₓ =
3 of PUSCH when simultaneous PUSCH repetition scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14-15 | reserved |

ii) Optionally, the bit size of the second SRS resource indicator field is 2, 3 or 4 bits according to the number of transmission layers indicated by the second SRS resource indicator field field and the configured value of the maximum SRS resources (denoted as N_{SRS}) of the PUSCH repetition. Further, the SRI candidates indicated by the first SRS resource indicator field are included in Table 3-2.

TABLE 3-2
SRI candidates indicated by the second SRS resource indicator
field in the case of maximum transmission layers Lₘₐₓ =
3 of PUSCH when simultaneous PUSCH repetition scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 0 | 0, 1 | 2 | 2 | 2 | 2 |
| 1 | 2 layers: | 3 | 1 layer: | 3 | 3 |
| | reserved | | reserved | | |
| | | 0 | 0, 1 | 4-7 | 1 layer: |
| | | | | | reserved |
| | | 1 | 0, 2 | 0 | 0, 1 |
| | | 2 | 1, 2 | 1 | 0, 2 |
| | | 3 | 2 layers: | 2 | 0, 3 |
| | | | reserved | | |
| | | 0 | 0, 1, 2 | 3 | 1, 2 |
| | | 1-3 | 3 layers: | 4 | 1, 3 |
| | | | reserved | | |
| | | | | 5 | 2, 3 |
| | | | | 6-7 | 2 layers: |
| | | | | | reserved |
| | | | | 0 | 0, 1, 2 |
| | | | | 1 | 0, 1, 3 |
| | | | | 2 | 0, 2, 3 |
| | | | | 3 | 1, 2, 3 |
| | | | | 4-7 | 3 layers: |
| | | | | | reserved |

### Embodiment Examples 4

These embodiments may incorporate SRI indication for NCB based simultaneous PUSCH transmission in MTRP operation.

If at least one of the following conditions is satisfied,
1) The UE is scheduled to transmit more than one PUSCH transmission simultaneously, wherein the time domain of these PUSCH transmissions are fully or partially overlapped.
   a. Wherein, the PUSCH transmission can be at least one of: inter-slot based PUSCH transmission or intra-slot based PUSCH transmission.
   c. Wherein, the codeword of each of PUSCH transmissions is different.
2) The one or more PUSCH transmissions are configured with one or more SRS resource sets, which are configured in srs-ResourceSetToAddModList or srs-ResourceSetToAddModListDCI-0-2 with higher layer parameter usage in SRS-ResourceSet set to ‘nonCodebook’.
3) For non-codebook based transmission scheme, the PUSCH can be scheduled by DCI format 0_1, DCI format 0_2 or RRC signaling.
4) For these PUSCH transmissions transmitted simultaneously, each of PUSCH transmissions is associated with one SRS resource set.
5) These PUSCH transmissions are indicated with different beams or spatial relations.
   the UE may gets and applies one or a plurality of SRIs to these PUSCH transmissions.
1) Optionally, the plurality of SRIs are given by DCI indication or RRC signaling. In some embodiments, the DCI indication can be at least one of the DCI format 0_1 or DCI format 0_2, the RRC signaling can be at least one of the higher layer parameter srs-ResourceIndicator or the higher layer parameter srs-ResourceIndicator2-r17.
   a. In some embodiments, each of SRIs is separately indicated by a SRS resource indicator field in the DCI.
      a) In some embodiments, the overhead of each SRS resource indicator field of each SRI depends on at least one of the following factors:
         i. Factor-1: the maximum transmission layers of the PUSCH transmission;
         i) For an example, the maximum transmission layers is configured by the higher layer parameter maxMIMO-Layers in PUSCH-ServingCellConfig of the PUSCH transmission, or is given by the maximum number of layers for PUSCH supported by the UE for the serving cell of the PUSCH transmission.
         ii) Optionally, the number of transmission layers of each PUSCH transmission can be the same or different.
         iii) Optionally, the maximum number of transmission layers of all PUSCH transmissions should be equal to 2, 3 or 4.
         a. In some embodiments, the number of transmission layers of each PUSCH transmission can be 1, 2, or 3.
         iv) Optionally, if the number of all PUSCH transmissions is two, the transmission layer combinations of the all PUSCH transmission comprise at least one of: {1 layer, 1 layer}, {1 layer, 2 layers}, {1 layer, 3 layers}, {2 layers, 1 layer}, {2 layers, 2 layers} or {3 layers, 1 layer}. In some embodiments, each value of the combination is associated with an SRS resource set, for example, the first and second values are associated with the first and second SRS resource sets, respectively.
         v) Optionally, the maximum number of transmission layers of each SRS resource set of each PUSCH transmission is separately configured by the higher layer parameter maxMIMO-Layers in PUSCH-ServingCellConfig of the PUSCH transmission or is given by the maximum number of layers for PUSCH supported by the UE for the serving cell of the PUSCH transmission, where the candidate values of maxMIMO-Layers or reported by the UE of each SRS resources set of each PUSCH transmission comprise at least one of: 1, 2 or 3.
         ii. Factor-2: the number of configured SRS resources in a SRS resource set associated with the PUSCH transmission.
         i) For an example, the number of configured SRS resources in a SRS resource set is configured by the higher layer parameter srs-ResourceIdList in SRS-ResourceSet of the PUSCH transmission.
         ii) Optionally, the number of configured SRS resources in a SRS resource set of each PUSCH transmission can be the same or different.
         iii) Optionally, the maximum number of configured SRS resources in a SRS resource set of each PUSCH transmission is separately configured, where the candidate values comprise at least one of: 1, 2, 3 or 4.
         iv) Optionally, if the number of all PUSCH transmissions is two, the combinations of the configured SRS resources of these two PUSCH transmissions comprise at least one of: {1, 1}, {1, 2}, {1, 3}, {1, 4}, {2, 1}, {2, 2}, {2, 3}, {2, 4}, {3, 1}, {3, 2}, {3, 3}, {3, 4}, {4, 1}, {4, 2}, {4, 3} or {4, 4}. In some embodiments, each value of the combination is associated with an SRS resource set of the PUSCH transmission. For example, the first and second values are associated with the first and second SRS resource sets, respectively.
   b. In some embodiments, the plurality of SRIs are jointly indicated by a single SRS resource indicator field in the DCI.
      a) Optionally, a mixed SRI is indicated by the single SRS resource indicator field and is combined by a plurality of SRIs, wherein each of SRIs is indicated by different bits in the SRS resource indicator field.
         i. For an example, if the number of PUSCH transmissions is 2, MSB bits are used to indicate the first SRI of the first PUSCH transmission and LSB bits are used to indicate the second SRI of the second PUSCH transmission.
      b) Optionally, a mixed SRI is indicated by the SRS resource indicator field and the value of the mixed SRI comprises the combination of the SRS resources for each PUSCH transmission.
   c. Further, the spatial phase coefficient of the PUSCH transmissions is determined and indicated to the UE.
      a) Optionally, the spatial phase coefficient is a relative value between two PUSCH transmissions.
      b) Optionally, the spatial phase coefficient is a absolute value of the PUSCH transmission.
      c) Optionally, the spatial phase coefficient is indicated by the SRS resource indicator field.
      d) Optionally, the spatial phase coefficient is indicated by a field in DCI exclusively.
      e) Optionally, the candidate values of the spatial phase coefficient comprise at least one of: 1, j, −1 or −j.
   d. In some embodiments, if these PUSCH transmissions are scheduled by DCI format 0_1 or DCI format 0_2, the UE determines the SRI of each PUSCH transmission which indicated by SRS resource indicator field(s) in DCI if the number of the associated SRS resources of the PUSCH transmission is more than 1.
      a) Further, the candidates of SRI which indicated by the SRS resource indicator field are dedicated to different cases:
         i. In some embodiments, if the number of the PUSCH transmissions is 2 and the maximum number of transmission layers (denoted as Lₘₐₓ) of each PUSCH transmission is 1:
         i) Optionally, the bit size of the first or the second SRS resource indicator field is 1, 2 or 2 bits according to the configured value of the maximum SRS resources (denoted as N_{SRS}) of the PUSCH transmission. Further, the SRI candidates indicated by the first or the second SRS resource indicator field are included in Table 1-1.

TABLE 1-1
SRI candidates indicated by the first or the second SRS resource
indicator field in the case of maximum transmission layers
Lₘₐₓ = 1 of PUSCH when simultaneous PUSCH transmission scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| | | 2 | 2 | 2 | 2 |
| | | 3 | reserved | 3 | 3 |

b) Further, the candidates of SRI which indicated by the SRS resource indicator field are dedicated to different cases:
   i. In some embodiments, if the number of the PUSCH transmissions is 2 and the maximum number of transmission layers (denoted as Lₘₐₓ) of each PUSCH transmission is 2:
   i) Optionally, the bit size of the first or the second SRS resource indicator field is 2, 3 or 4 bits according to the configured value of the maximum SRS resources (denoted as N_{SRS}) of the PUSCH transmission. Further, the SRI candidates indicated by the first or the second SRS resource indicator field are included in Table 2-1.

TABLE 2-1
SRI candidates indicated by the first or the second SRS resource
indicator field in the case of maximum transmission layers
Lₘₐₓ = 2 of PUSCH when simultaneous PUSCH transmission scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6-7 | reserved | 6 | 0, 3 |
| | | | | 7 | 1, 2 |
| | | | | 8 | 1, 3 |
| | | | | 9 | 2, 3 |
| | | | | 10-15 | reserved |

c) Further, the candidates of SRI which indicated by the SRS resource indicator field are dedicated to different cases:
   i. In some embodiments, if the number of the PUSCH transmissions is 2 and the maximum number of transmission layers (denoted as Lₘₐₓ) of each PUSCH transmission is 3:
   i) Optionally, the bit size of the first or the second SRS resource indicator field is 2, 3 or 4 bits according to the configured value of the maximum SRS resources (denoted as N_{SRS}) of the PUSCH transmission. Further, the SRI candidates indicated by the first or the second SRS resource indicator field are included in Table 3-1.

TABLE 3-1
SRI candidates indicated by the first or the second SRS resource
indicator field in the case of maximum transmission layers
Lₘₐₓ = 3 of PUSCH when simultaneous PUSCH transmission scheme

| Bit field | | Bit field | | Bit field | |
|---|---|---|---|---|---|
| mapped | SRI(s), | mapped | SRI(s), | mapped | SRI(s), |
| to index | N_{SRS} = 2 | to index | N_{SRS} = 3 | to index | N_{SRS} = 4 |
| 0 | 0 | 0 | 0 | 0 | 0 |
| 1 | 1 | 1 | 1 | 1 | 1 |
| 2 | 0, 1 | 2 | 2 | 2 | 2 |
| 3 | reserved | 3 | 0, 1 | 3 | 3 |
| | | 4 | 0, 2 | 4 | 0, 1 |
| | | 5 | 1, 2 | 5 | 0, 2 |
| | | 6 | 0, 1, 2 | 6 | 0, 3 |
| | | 7 | reserved | 7 | 1, 2 |
| | | | | 8 | 1, 3 |
| | | | | 9 | 2, 3 |
| | | | | 10 | 0, 1, 2 |
| | | | | 11 | 0, 1, 3 |
| | | | | 12 | 0, 2, 3 |
| | | | | 13 | 1, 2, 3 |
| | | | | 14-15 | reserved |

### Embodiment Examples 5

These embodiments may incorporate SRI indication for CB based simultaneous PUSCH repetition in MTRP operation.

If at least one of the following conditions is satisfied,
1) The UE is scheduled to transmit more than one PUSCH repetition simultaneously, wherein the time domain of these PUSCH repetitions are fully or partially overlapped.
   a. Wherein, the PUSCH repetition can be at least one of: inter-slot based PUSCH repetition or intra-slot based PUSCH repetition.
   b. Wherein, these PUSCH repetitions are transmitted with same or different RV.
2) The one or more PUSCH repetitions are configured with one or more SRS resource sets, which are configured in srs-ResourceSetToAddModList or srs-ResourceSetToAddModListDCI-0-2 with higher layer parameter usage in SRS-ResourceSet set to ‘codebook’.
3) For codebook based transmission scheme, the PUSCH can be scheduled by DCI format 0_1, DCI format 0_2 or RRC signaling.
4) For these PUSCH repetitions transmitted simultaneously, each of PUSCH repetitions is associated with one SRS resource set.
5) These PUSCH repetitions are indicated with different beams or spatial relations.

The UE may gets and applies one or a plurality of SRIs to these PUSCH repetitions.
1) Optionally, the plurality of SRIs are given by DCI indication or RRC signaling. In some embodiments, the DCI indication can be at least one of the DCI format 0_1 or DCI format 0_2, the RRC signaling can be at least one of the higher layer parameter srs-ResourceIndicator or the higher layer parameter srs-ResourceIndicator2-r17.
   a. In some embodiments, each of SRIs is separately indicated by a SRS resource indicator field in the DCI.
      a) In some embodiments, the overhead of each SRS resource indicator field of each SRI depends on the number of configured SRS resources in a SRS resource set associated with the PUSCH repetition.
         i) For an example, the number of configured SRS resources in a SRS resource set is determined by the higher layer parameter srs-ResourceIdList in SRS-ResourceSet of the PUSCH repetition.
         ii) Optionally, the maximum number of configured SRS resources in a SRS resource set of each PUSCH repetition is the same, where the candidate values comprise at least one of: 1 or 2.
         a. Further, if the higher layer parameter ul-FullPowerTransmission is set to ‘fullpowerMode2’ of a PUSCH repetition, and subject to UE capability, up to 4 SRS resources can be configured in a SRS resource set.
         iii) Optionally, the number of SRS ports for all SRS resources within a SRS resource set is the same.
   b. In some embodiments, the plurality of SRIs are jointly indicated by a single SRS resource indicator field in the DCI.
      a) Optionally, a mixed SRI is indicated by the single SRS resource indicator field and is combined by a plurality of SRIs, wherein each of SRIs is indicated by different bits in the SRS resource indicator field.
         i. For an example, if the number of PUSCH repetitions is 2, MSB bits are used to indicate the first SRI of the first PUSCH repetition and LSB bits are used to indicate the second SRI of the second PUSCH repetition.
      b) Optionally, a mixed SRI is indicated by the SRS resource indicator field and the value of the mixed SRI comprises the combination of the SRS resources for each PUSCH repetition.

### Embodiment Examples 6

These embodiments may incorporate SRI indication for CB based simultaneous PUSCH transmission (e.g., non-repetition) in MTRP operation.

If at least one of the following conditions is satisfied,
1) The UE is scheduled to transmit more than one PUSCH transmission simultaneously, wherein the time domain of these PUSCH transmissions are fully or partially overlapped.
   a. Wherein, the PUSCH transmission can be at least one of: inter-slot based PUSCH transmission or intra-slot based PUSCH transmission.
   b. Wherein, the codeword of each of PUSCH transmissions is different.
2) The one or more PUSCH transmission are configured with one or more SRS resource sets, which are configured in srs-ResourceSetToAddModList or srs-ResourceSetToAddModListDCI-0-2 with higher layer parameter usage in SRS-ResourceSet set to ‘codebook’.
3) For codebook based transmission scheme, the PUSCH can be scheduled by DCI format 0_1, DCI format 0_2 or RRC signaling.
4) For these PUSCH transmissions transmitted simultaneously, each of PUSCH transmissions is associated with one SRS resource set.
5) These PUSCH transmissions are indicated with different beams or spatial relations.
   the UE may gets and applies one or a plurality of SRIs to these PUSCH repetitions.
1) Optionally, the plurality of SRIs are given by DCI indication or RRC signaling. In some embodiments, the DCI indication can be at least one of the DCI format 0_1 or DCI format 0_2, the RRC signaling can be at least one of the higher layer parameter srs-ResourceIndicator or the higher layer parameter srs-ResourceIndicator2-r17.
   a. In some embodiments, each of SRIs is separately indicated by a SRS resource indicator field in the DCI.
      a) In some embodiments, the overhead of each SRS resource indicator field of each SRI depends on the number of configured SRS resources in a SRS resource set associated with the PUSCH transmission.
         i) For an example, the number of configured SRS resources in a SRS resource set is determined by the higher layer parameter srs-ResourceIdList in SRS-ResourceSet of the PUSCH transmission.
         ii) Optionally, the maximum number of configured SRS resources in a SRS resource set of each PUSCH repetition can be the same or different, where the candidate values comprise at least one of: 1 or 2.
         a. Further, if the higher layer parameter ul-FullPowerTransmission is set to ‘fullpowerMode2’ of a PUSCH repetition, and subject to UE capability, up to 4 SRS resources can be configured in a SRS resource set.
         iii) Optionally, the number of SRS ports for all SRS resources within a SRS resource set can be the same or different.
   b. In some embodiments, the plurality of SRIs are jointly indicated by a single SRS resource indicator field in the DCI.
      a) Optionally, a mixed SRI is indicated by the single SRS resource indicator field and is combined by a plurality of SRIs, wherein each of SRIs is indicated by different bits in the SRS resource indicator field.
         i. For an example, if the number of PUSCH repetitions is 2, MSB bits are used to indicate the first SRI of the first PUSCH repetition and LSB bits are used to indicate the second SRI of the second PUSCH repetition.
      b) Optionally, a mixed SRI is indicated by the SRS resource indicator field and the value of the mixed SRI comprises the combination of the SRS resources for each PUSCH repetition.

It will be appreciated by one of skill in the art that the present document discloses some solutions to determine the transmission precoder and spatial relation indication are proposed for the case of multiple simultaneous PUSCH repetitions/transmissions transmitted from multi-panel and toward to multi-TRP. More precisely,

With respect to the determination of transmission precoder, taking the following factors into consideration respectively may be implemented by various preferred embodiments:
The rules for determining the number of antenna ports.
The rules for determining the number of transmission layers.
The rules for determining the power ratio s.
The rules for determining the overhead of TPMI field in DCI.
The rules for determining the candidate values of precoding matrix.
The rules for determining the spatial phase coefficients among multiple panels.
The rules for determining the mapping between the transmission layers and the antenna ports.

With respect to the determination of spatial relation indication, taking the following factors into consideration respectively by preferred embodiments:
The rules for determining the number of transmission layers.
The rules for determining the overhead of SRI field in DCI.
The rules for determining the candidate values of SRI.
The rules for determining the spatial phase coefficients among multiple panels.

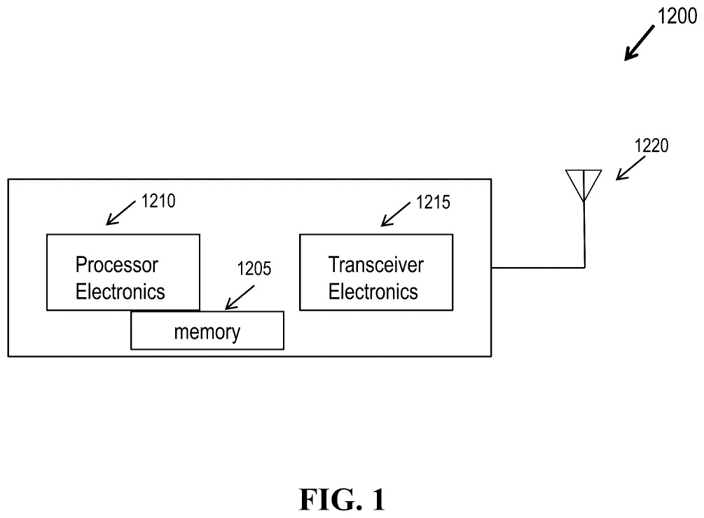

FIG. 1 is a block diagram of an example implementation of a wireless communication apparatus 1200. The methods described herein may be implemented by the apparatus 1200. In some embodiments, the apparatus 1200 may be the first communication device such as a base station or a network device of a wireless network and the second communication device may be UE. In some embodiments, the apparatus 1200 may be the second communication device such as UE. The apparatus 1200 includes one or more processors, e.g., processor electronics 1210, transceiver circuitry 1215 and one or more antenna 1220 for transmission and reception of wireless signals. The apparatus 1200 may include memory 1205 that may be used to store data and instructions used by the processor electronics 1210. The apparatus 1200 may also include an additional network interface to one or more core networks or a network operator's additional equipment. This additional network interface, not explicitly shown in the figure, may be wired (e.g., fiber or Ethernet) or wireless.

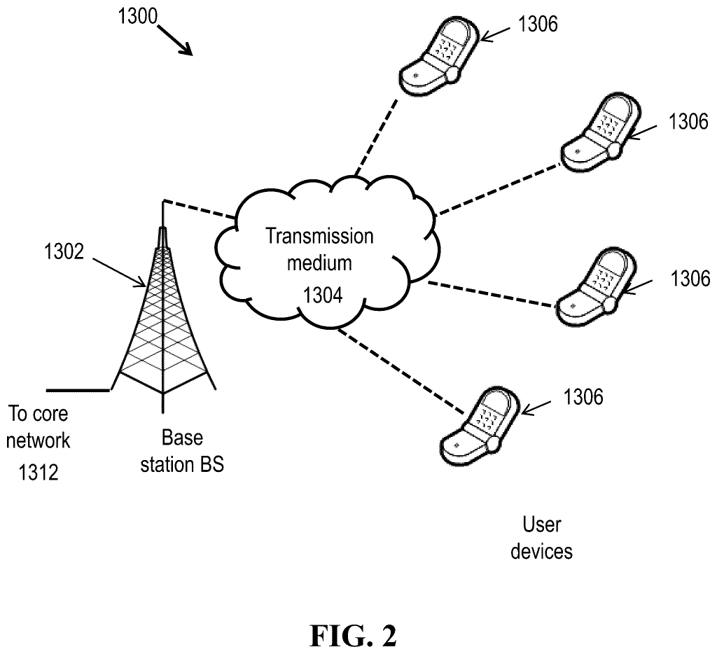

FIG. 2 depicts an example of a wireless communication system 1300 in which the various techniques described herein can be implemented. The system 1300 includes a base station 1302 that may have a communication connection with core network (1312) and to a wireless communication medium 1304 to communicate with one or more user devices 1306. The user devices 1306 could be smartphones, tablets, machine to machine communication devices, Internet of Things (IoT) devices, and so on.

Some preferred embodiments may incorporate the following solution features.

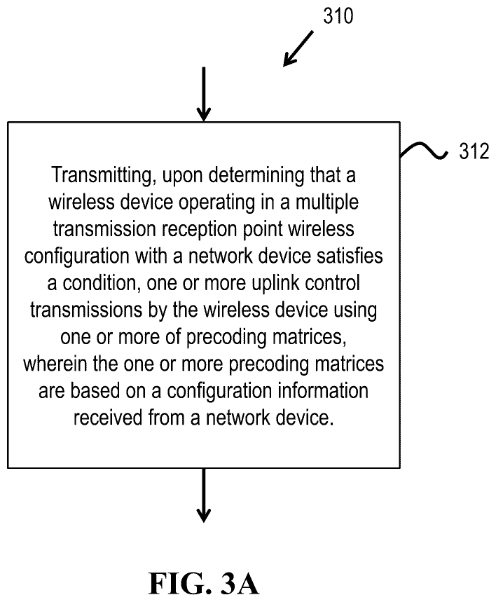

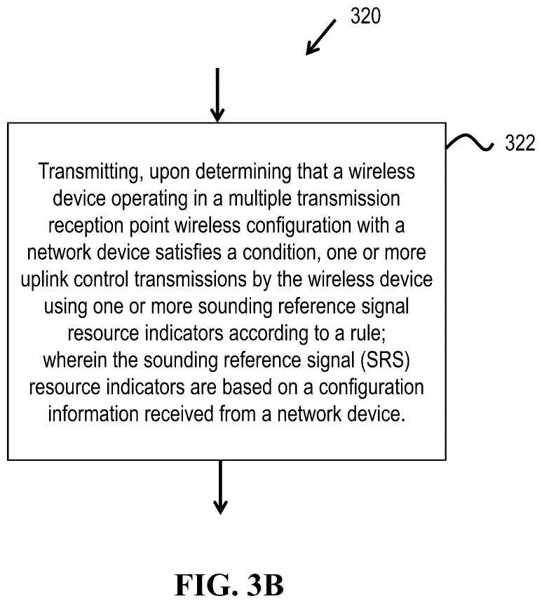

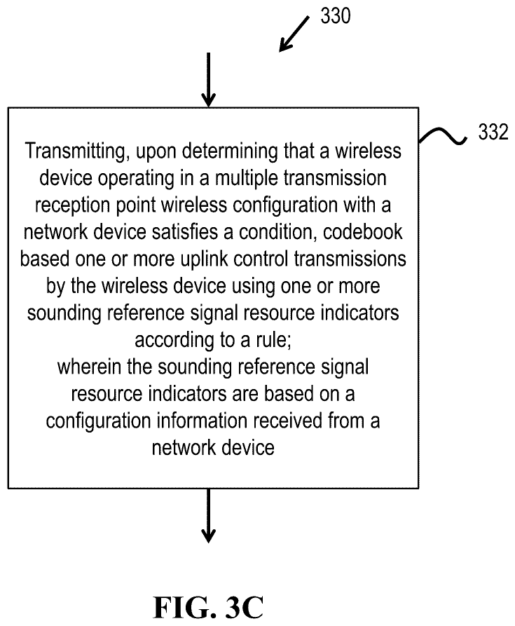

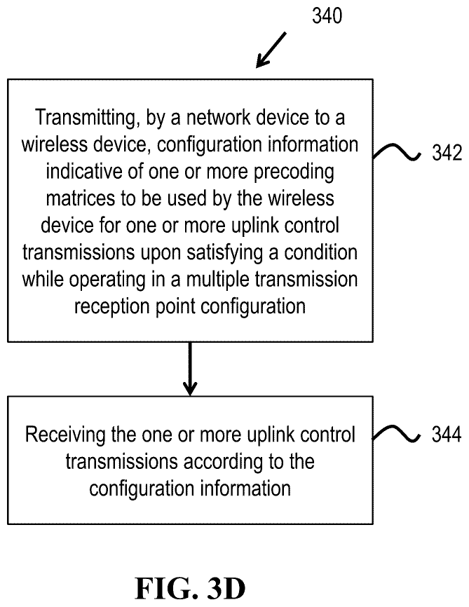

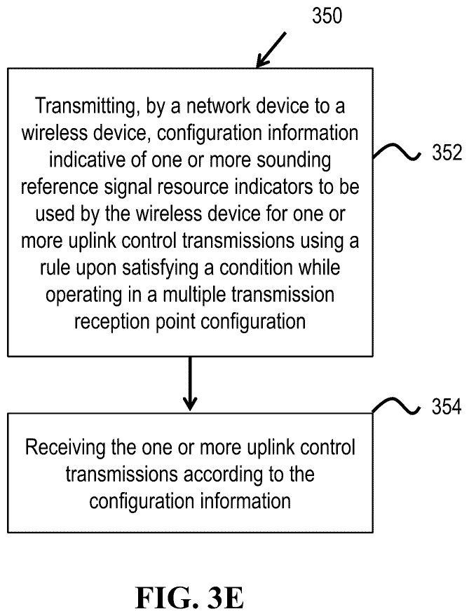

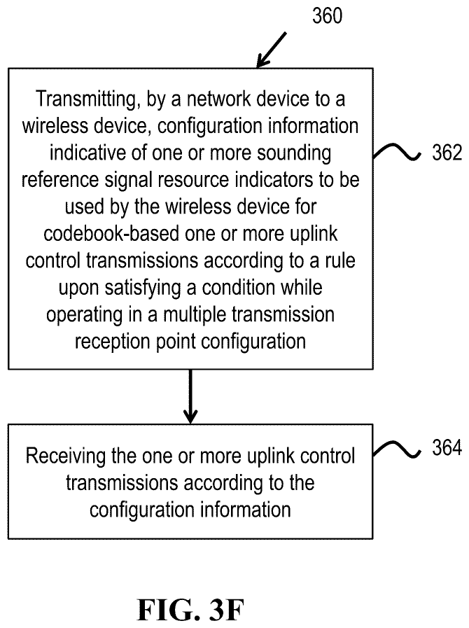

1. A method of wireless communication (e.g., method 310 as shown in FIG. 3A), comprising: transmitting 312, upon determining that a wireless device operating in a multiple transmission reception point wireless configuration with a network device satisfies a condition, one or more uplink control transmissions by the wireless device using one or more of precoding matrices, wherein the one or more precoding matrices are based on a configuration information received from a network device.

2. The method of solution 1, wherein the one or more uplink control transmissions comprise one or more physical uplink shared channel (PUSCH) transmission occasions or one or more PUSCH transmission repetitions.

3. The method of solution 2, wherein the condition includes that the one or more PUSCH transmission occasions or the one or more PUSCH repetitions are associated with one or more sounding reference signal (SRS) resource sets.

4. The method of any of solutions 2-3, wherein the condition includes that the wireless device is scheduled to transmit more than one PUSCH repetitions simultaneously such that, in a time domain, the more than one PUSCH repetitions at least partially overlap.

5. The method of any of solutions 2-3, wherein the condition includes that each PUSCH repetition is associated with one SRS resource set.

6. The method of any of above solutions wherein the one or more precoding matrices represent a precoder used over one or more transmission layers.

7. The method of any of above solutions, wherein the one or more precoding matrices are determined via a downlink control indication (DCI) or a radio resource control (RRC) message.

8. The method of solution 1, wherein the scheduling information is received in a downlink control information (DCI) that indicates precoding information or a field indicative of a number of layers.

9. The method of solution 8, wherein an overhead of the precoding information and the field is dependent on at least one of: (1) a maximum number of transmission layers, (2) a maximum number of antenna ports, or (3) a maximum coherence capability of antenna ports used by the wireless device for the one or more PUSCH repetitions.

10. The method of solutions 8-9, wherein the precoding information includes spatial phase coefficients of the one or more precoding matrices according to a spatial phase indication rule.

11. The method of solution 10, wherein the spatial phase indication rule specifies at least one of: indicating spatial phase coefficients coded as a relative value between two consecutive precoding matrices, indicating spatial phase coefficients as non-differentially encoded values indicating spatial phase coefficients according to the precoding information and the number of layers indicating spatial phase coefficients by a dedicated field of the DCI, or indicating spatial phase coefficients to be one of four values including 1, j, −1 or −j.

12. The method of any of above solutions, wherein a number of antenna ports used by the one or more uplink control transmissions satisfy an antenna port number rule, wherein the antenna port number rule is at least one of:
all of the one or more uplink control transmissions use a same number of antenna ports;
the one or more uplink control transmissions use different number of antenna ports;
the one or more uplink control transmissions use 1, 2 or 4 antennas ports; or
the number of antenna ports for each uplink control transmission is configured by a higher layer signaling.

13. The method of any of above solutions, wherein a number of transmission layers of the one or more precoding matrices satisfy a transmission layer rule, wherein the transmission layer rule specifies at least one of:
a same number of transmission layers is used by each of the one or more precoding matrices of the one or more uplink control transmissions;
a maximum number of transmission layers used by the one or more uplink control transmission layers is 2 or 4; or
the maximum number of transmission layers used by the one or more uplink control transmissions layers is 1 or 2.

14. The method of any of solutions 2-12, wherein a number of transmission layers of the one or more precoding matrices satisfy a transmission layer rule, wherein the transmission layer rule specifies that: a maximum number of transmission layer for each SRS resource set of each uplink control transmission is configured by a higher layer message to be 1 or 2.

15. The method of any of solutions 2-12, wherein a number of transmission layers of the one or more precoding matrices satisfy a transmission layer rule, wherein the transmission layer rule specifies that: a maximum number of transmission layers of all uplink control transmissions associated with one or more SRS resource sets is configured by a higher layer signal to be 2 or 4.

16. The method of any of above solutions, wherein in case that each of the one or more uplink control transmissions uses a different transmission layer, then a mapping between a transmission layer used by a given uplink control transmission and a corresponding antenna ports is determined using a mapping rule.

17. The method of solution 16, wherein the mapping rule specifies that indices of antenna ports for the one or more uplink control transmission are separately ordered according to an indicated SRS resource for the one or more uplink control transmission.

18. The method of solution 16, wherein the mapping rule specifies that indices of transmission layers for the one or more uplink control transmissions are separately ordered according to an indicated or configured transmission layers for the one or more uplink control transmissions.

19. The method of solution 16, wherein the mapping rule specifies that an indicated precoding matrix is used for each uplink control transmission.

20. The method of any of above solutions, wherein a power ratio of a precoding matrix of the one or more uplink control transmissions satisfies at least one of: a higher layer parameter each uplink control transmission is set to codebook; or a linear value corresponding to a total power of the uplink control transmissions is scaled by a power ratio.

21. The method of solution 20, wherein the power ratio is determined by:

$$s = \frac{{N}_{{p}_{nz}}}{{{\sum }_{i = 1}}^{n} {N}_{{p}_{nz , i}}} ;$$

wherein, s denotes the power ratio; N_{P}_{_{nz}} denotes a number of antenna ports with non-zero transmission power of a corresponding uplink control transmission; N_{P}_{_{nz,i}} denotes a number of antenna ports with non-zero transmission power of an i-th uplink control transmission, n denotes a total number of the one or more uplink control transmissions which would be transmitted simultaneously; i=1, . . . , n is a variable that is associated with up to n uplink control transmissions.

Embodiments 1 and 2 provide further example features of the above-recited solutions.

22. A method of wireless communication (e.g., method 320 as shown in FIG. 3B), comprising: transmitting 322, upon determining that a wireless device operating in a multiple transmission reception point wireless configuration with a network device satisfies a condition, one or more uplink control transmissions by the wireless device using one or more sounding reference signal resource indicators according to a rule; wherein the sounding reference signal (SRS) resource indicators are based on a configuration information received from a network device.

23. The method of solution 22, wherein the condition is that the one or more uplink control transmissions are configured with one or more SRS resource sets.

24. The method of solution 22, wherein the condition includes that the wireless device is scheduled to transmit more than one uplink control transmissions simultaneously such that, in a time domain, the more than one uplink transmissions at least partially overlap.

25. The method of solution 22, wherein the condition is that each of the one or more uplink transmissions is associated with a corresponding SRS resource set.

26. The method of any of solutions 22-25, wherein the one or more uplink control transmissions comprise one or more physical uplink shared channel (PUSCH) transmission occasions or one or more PUSCH transmission repetitions.

27. The method of solution 26, wherein the wireless device receives one or more sounding reference signal resource indicators, SRIs, and applies the one or more SRIs to the one or more uplink control transmissions.

28. The method of solution 27, wherein the one or more SRIs are separately indicated by a resource indicator field in a downlink control information (DCI).

29. The method of solution 22, wherein an overhead of each SRS resource indicator field of each SRI depends on one or more of following factors: a maximum number of transmission layers of the one or more uplink control transmissions; or a number of configured SRS resources in an SRS resource set associated with the one or more uplink control transmissions.

30. The method of any of solutions 26-29, wherein spatial phase coefficients of the one or more uplink transmissions are indicated to the wireless device, wherein the spatial phase coefficients comprise a relative value between two uplink control transmissions or an absolute value.

31. The method of any of solutions 26-30, wherein spatial phase coefficients of the one or more uplink transmissions are indicated to the wireless device, and wherein the spatial phase coefficients are indicated by the SRS resource indicator field or in a field of DCI or comprises a value from 1, j, −1 or −j.

Embodiments 3 and 4 provide further example features of the above-recited solutions.

32. A method of wireless communication (e.g., method 330 as shown in FIG. 3C), comprising: transmitting 332, upon determining that a wireless device operating in a multiple transmission reception point wireless configuration with a network device satisfies a condition, codebook based one or more uplink control transmissions by the wireless device using one or more sounding reference signal resource indicators according to a rule; wherein the sounding reference signal resource indicators are based on a configuration information received from a network device.

33. The method of solution 32, wherein the condition includes that the wireless device is scheduled to transmit more than one uplink control transmissions simultaneously such that, in a time domain, the more than one uplink transmissions at least partially overlap.

34. The method of solution 32, wherein the condition is that the one or more uplink control transmissions are configured with one or more sounding reference signal, SRS, resource sets.

35. The method of solution 32, wherein the condition is that each of the one or more uplink transmissions is associated with a corresponding SRS resource set.

36. The method of any of solutions 32-35, wherein the one or more uplink control transmissions comprise one or more physical uplink shared channel (PUSCH) transmission occasions or one or more PUSCH transmission repetitions.

37. The method of solution 36, wherein the configuration information comprises one or more sounding reference signal resource indicators that are received in a downlink control information (DCI) or a radio resource control (RRC) message.

38. The method of solution 37, wherein an overhead of each SRS resource indicator depends on a number of configured SRS resources in an SRS resource set associated with the one or more uplink transmissions.

Embodiments 5 and 6 provide further example features of the above-recited solutions.

39. A method of wireless communication (e.g., method 340 as shown in FIG. 3D), comprising: transmitting 342, by a network device to a wireless device, configuration information indicative of one or more precoding matrices to be used by the wireless device for one or more uplink control transmissions upon satisfying a condition while operating in a multiple transmission reception point configuration; and receiving 344 the one or more uplink control transmissions according to the configuration information.

Embodiments 1 and 2 provide further example features of the above-recited solutions. The above solution may further include features as recited in above-listed solutions 2-21.

40. A method of wireless communication (e.g., method 350 as shown in FIG. 3E), comprising: transmitting 352, by a network device to a wireless device, configuration information indicative of one or more sounding reference signal resource indicators to be used by the wireless device for one or more uplink control transmissions using a rule upon satisfying a condition while operating in a multiple transmission reception point configuration; and receiving 354 the one or more uplink control transmissions according to the configuration information.

Embodiments 3 and 4 provide further example features of the above-recited solutions. The above solution may further include features as recited in above-listed solutions 23-31.

41. A method of wireless communication (e.g., method 360 as shown in FIG. 3F), comprising: transmitting 362, by a network device to a wireless device, configuration information indicative of one or more sounding reference signal resource indicators to be used by the wireless device for codebook-based one or more uplink control transmissions according to a rule upon satisfying a condition while operating in a multiple transmission reception point configuration; and receiving 364 the one or more uplink control transmissions according to the configuration information.

Embodiments 5 and 6 provide further example features of the above-recited solutions. The above solution may further include features as recited in above-listed solutions 33-38.

42. A wireless communication apparatus comprising a processor configured to implement a method recited in any of solutions 1-41.

43. A computer-readable medium having processor-executable code stored thereupon, the code, upon execution by the processor, causing the processor to implement a method recited in any of solutions 1-41.

It will be appreciated that techniques for achieving different reference signal resource densities in time and/or frequency domain are realized. In one advantageous aspect, the disclosed techniques may be used by a transmitter (e.g., a base station) to schedule a denser resource grid of reference signals in time-frequency regions where there is a greater chance of interference, e.g., time-frequency regions where uplink and downlink transmissions occupy adjacent or proximate time slots of subcarriers. It will further be appreciated by one of skill in the art that the disclosed techniques may be used to reserve certain resource elements as zero-power transmission resources (e.g., a reference signal transmission that comprises no signal transmission). Furthermore, embodiments may be able to divide all available time-frequency resource into multiple regions (also referred to as areas in this document) and resource density may be specified on a region-by-region basis. Data and reference signal transmissions may fall entirely within a single region, or may occupy multiple regions, thereby provide a flexible resource density organization.

The disclosed and other embodiments, modules and the functional operations described in this document can be implemented in digital electronic circuitry, or in computer software, firmware, or hardware, including the structures disclosed in this document and their structural equivalents, or in combinations of one or more of them. The disclosed and other embodiments can be implemented as one or more computer program products, i.e., one or more modules of computer program instructions encoded on a computer readable medium for execution by, or to control the operation of, data processing apparatus. The computer readable medium can be a machine-readable storage device, a machine-readable storage substrate, a memory device, a composition of matter effecting a machine-readable propagated signal, or a combination of one or more them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a standalone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

The processes and logic flows described in this document can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application specific integrated circuit).

Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

While this document contains many specifics, these should not be construed as limitations on the scope of an invention that is claimed or of what may be claimed, but rather as descriptions of features specific to particular embodiments. Certain features that are described in this document in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or a variation of a sub-combination. Similarly, while operations are depicted in the drawings in a particular order, this should not be understood as requiring that such operations be performed in the particular order shown or in sequential order, or that all illustrated operations be performed, to achieve desirable results.

Only a few examples and implementations are disclosed. Variations, modifications, and enhancements to the described examples and implementations and other implementations can be made based on what is disclosed.

1. A method of wireless communication, comprising:
transmitting, upon determining that a wireless device operating in a multiple transmission reception point wireless configuration with a network device satisfies a condition, one or more uplink control transmissions by the wireless device using one or more of precoding matrices,
wherein the one or more precoding matrices are based on a configuration information received from a network device.

2. The method of claim 1, wherein the one or more uplink control transmissions comprise one or more physical uplink shared channel (PUSCH) transmission occasions or one or more PUSCH transmission repetitions.

3. (canceled)

4. The method of claim 2, wherein the condition includes that the wireless device is scheduled to transmit more than one PUSCH transmissions simultaneously such that, in a time domain, the more than one PUSCH transmissions at least partially overlap.

5. The method of claim 2, wherein the condition includes that each PUSCH transmission is associated with one SRS resource set.

6. The method of claim 1, wherein the one or more precoding matrices represent a precoder used over one or more transmission layers.

7. (canceled)

8. The method of claim 1, wherein scheduling information is received in a downlink control information (DCI) that indicates precoding information or a field indicative of a number of layers.

9. The method of claim 8, wherein an overhead of the precoding information and the field is dependent on at least one of: (1) a maximum number of transmission layers, (2) a maximum number of antenna ports, or (3) a maximum coherence capability of antenna ports used by the wireless device for one or more PUSCH transmissions.

10-11. (canceled)

12. The method of claim 1, wherein a number of antenna ports used by the one or more uplink control transmissions satisfy an antenna port number rule, wherein the antenna port number rule is at least one of:
all of the one or more uplink control transmissions use a same number of antenna ports;
the one or more uplink control transmissions use different number of antenna ports;
the one or more uplink control transmissions use 1, 2 or 4 antennas ports; or
the number of antenna ports for each uplink control transmission is configured by a higher layer signaling.

13. The method of claim 1, wherein a number of transmission layers of the one or more precoding matrices satisfy a transmission layer rule, wherein the transmission layer rule specifies at least one of:
a same number of transmission layers is used by each of the one or more precoding matrices of the one or more uplink control transmissions;
a maximum number of transmission layers used by the one or more uplink control transmission layers is 2 or 4; or
the maximum number of transmission layers used by the one or more uplink control transmissions layers is 1 or 2.

14-15. (canceled)

16. The method of claim 1, wherein in case that each of the one or more uplink control transmissions uses a different transmission layer, then a different transmission layer is mapped to an antenna port.

17-19. (canceled)

20. The method of claim 1, wherein a power ratio of a precoding matrix of the one or more uplink control transmissions satisfies at least one of:
a higher layer parameter each uplink control transmission is set to codebook; or
a linear value corresponding to a total power of the uplink control transmissions is scaled by a power ratio.

21. (canceled)

22. A method of wireless communication, comprising:
transmitting, upon determining that a wireless device operating in a multiple transmission reception point wireless configuration with a network device satisfies a condition, one or more uplink control transmissions by the wireless device using one or more sounding reference signal (SRS) resource indicators according to a rule;
wherein the one or more SRS resource indicators are based on a configuration information received from a network device.

23. (canceled)

24. The method of claim 22, wherein the condition includes that the wireless device is scheduled to transmit more than one uplink control transmissions simultaneously such that, in a time domain, the more than one uplink transmissions at least partially overlap.

25. The method of claim 22, wherein the condition is that each of the one or more uplink transmissions is associated with a corresponding SRS resource set.

26. The method of claim 22, wherein the one or more uplink control transmissions comprise one or more physical uplink shared channel (PUSCH) transmission occasions or one or more PUSCH transmission repetitions.

27-28. (canceled)

29. The method of claim 22, wherein an overhead of each SRS resource indicator field of each SRI depends on one or more of following factors:
a maximum number of transmission layers of the one or more uplink control transmissions; or
a number of configured SRS resources in an SRS resource set associated with the one or more uplink control transmissions.

30-31. (canceled)

32. A method of wireless communication, comprising:
transmitting, upon determining that a wireless device operating in a multiple transmission reception point wireless configuration with a network device satisfies a condition, codebook based one or more uplink control transmissions by the wireless device using one or more sounding reference signal resource indicators according to a rule;
wherein the sounding reference signal resource indicators are based on a configuration information received from a network device.

33. The method of claim 32, wherein the condition includes that the wireless device is scheduled to transmit more than one uplink control transmissions simultaneously such that, in a time domain, the more than one uplink transmissions at least partially overlap.

34. (canceled)

35. The method of claim 32, wherein the condition is that each of the one or more uplink transmissions is associated with a corresponding SRS resource set.

36-43. (canceled)

44. The method of claim 1, wherein a precoding matrix is used to indicate a precoder to be applied over one or more transmission layers.
